(19) United States
(12) Patent Application Publication
(10) Pub. No.: US 2020/0387888 A1
(43) Pub. Date: Dec. 10, 2020

(54) APPARATUS, SYSTEM, AND METHOD FOR OPERATING A DIGITAL TRANSACTION CARD

(71) Applicant: XARD Group Pty Ltd., Brighton (AU)

(72) Inventors: Mathieu Amiel, Brighton (AU); Robert Wilson, Brighton (AU)

(21) Appl. No.: 16/784,445

(22) Filed: Feb. 7, 2020

Related U.S. Application Data
(63) Continuation of application No. PCT/AU2018/050843, filed on Aug. 9, 2018.

(30) Foreign Application Priority Data
Aug. 9, 2017 (AU) 2017903183

(51) Int. Cl. G06Q 20/34; G06K 19/07; G06Q 20/32; G06Q 20/18; G06K 19/077

(52) U.S. Cl. CPC G06Q 20/341; G06K 19/0723; G06Q 20/3552; G06K 19/07707; G06Q 20/343; G06Q 20/3223; G06Q 20/18; G06Q 20/351

(57) ABSTRACT

Apparatus (512, 514, 516, 520) on a Digital Transaction Card (DTC) (518), the apparatus (512, 514, 516, 520) including a Digital Transaction Processing Unit (DTPU) (520) operable for executing an instruction from a standard command protocol, wherein the DTC (518) is operable to store one or more scripts (504), each script (504) including one or more instructions from the standard command protocol, the DTC (518) further operable to cause the DTPU (520) to execute the one or more instructions.

### CROSS REFERENCE TO RELATED APPLICATIONS

Continuation of International Application No. PCT/AU2018/050843 filed on Aug. 9, 2018. Priority is claimed from Australian Application No. 2017903183 filed on Aug. 9, 2017. Both of the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### BACKGROUND

The present invention relates generally to apparatus, methods, software, hardware, and systems for effecting digital transactions, including both financial and non-financial transactions. The present invention may be useful for transactions involving Digital Transaction Cards (DTCs). The present invention may be particularly useful for payment DTCs, such as credit cards and debit cards.

Credit cards, debit cards and other types of transaction cards or documents often include a magnetic stripe which stores information about the card or document, the holder of the card/document, an institution which has issued the card/document, and other information including card/document ID (for example, a PAN), expiry date, and the card/document holder's name. Typically, much of the information on the magnetic stripe is encoded for security.

Credit/debit cards typically also have the name of the cardholder, the card expiry date and the PAN embossed or printed on the card and may also include other security devices such as holograms. Credit/debit cards are enabled for transactions with Digital Transaction Devices (DTDs), such as Automatic Teller Machines (ATMs), Point-Of-Sale (POS) terminals, and Electronic Funds Transfer at Point-Of-Sale (EFTPOS) terminals, where the digital transaction devices are able to read the magnetic stripe when a user swipes the stripe through or inserts the card into a device. Some DTDs are operable with non-payment DTCs to effect non-payment digital transactions, including passport readers, age verification card readers and the like.

More recently, transaction cards, documents and other devices, such as watches and other wearable devices, have had integrated circuit chips, which can store the same information as a magnetic strip, along with much other information. The chip in these cards may be referred to a Secure Element (SE) and in many circumstances is a chip complying with EMVCo standards, known as an (Europay/MasterCard/Visa) EMV chip. In this specification, cards such as debit or credit cards having only a magnetic strip will be referred to as a magstripe Digital Transaction Cards (magstripe DTCs) and cards such as debit or credit cards having a SE/EMV chip (which may also have a magnetic stripe) will be referred to as chipped Digital Transaction Cards (DTCs) or simply as DTCs. During creation of a DTC, data particular to the cardholder, such as the cardholder's name, PAN and other details, are written into the SE/EMV chip in a process known as personalization by an agency known as a Personalization (or Perso) Bureau. Until recently, SE/EMV chips in DTCs have been operable with only a single card type in a single payment scheme, for example, the DTC may operate as one of a MasterCard credit card, a MasterCard debit card, a Visa credit card, a Visa debit card, or an Amex credit card, but cannot operate with two or more card types and/or payment schemes. A DTC operating with a single card type for a single payment scheme is known as having a single personality.

A DTC may be enabled for contact transactions and includes contact plates on a surface of the DTC which are connected for communication with the SE/EMV chip on the DTC. A contact transaction involves inserting (otherwise referred to as “dipping”) the DTC into a DTD having complementary contacts to communicate with the DTC contact plates.

A DTC may also be enabled for contactless transactions where the SE/EMV chip is connected to an antenna and the DTD has a corresponding antenna so that the SE/EMV and DTD can communicate via a Near Field Communication (NFC) protocol when the DTC is brought sufficiently proximal to the DTD. For example, where a DTC is in the form of a wearable payment device, such as a watch, such a payment device will not have a contact plate and can only be used for contactless payment transactions. Many public transport travel cards include an SE chip which operates for contactless digital transactions. Some documents, such as passports, may include a SE chip which can be read by a device through a contactless transaction.

Many DTCs, such as credit or debit cards, are operable for both contact and contactless digital transactions. Some DTCs have a magnetic stripe with similar information encoded thereon as the information contained in the SE/EMV chip.

An SE/EMV chip typically includes one or more of a Central Processing Unit (CPU), Read Only Memory (ROM), Random Access Memory (RAM), Electrically Erasable Programmable Read Only Memory (EEPROM), a crypto-coprocessor and an Input/Output (I/O) system. In some SE/EMV chips a part of memory, sometimes referred to as user memory, is set aside for storing applications and data particular to the operations required for the cardholder. Communication with a SE/EMV chip is effected through Application Protocol Data Units (APDUs) as specified in International Standard Organization (ISO) specifications. The APDUs include command APDUs and response APDUs.

For some payment digital transactions, the physical card need not be present, and only selected details from the card are provided to enable a transaction. Such transactions include internet transactions and Mail Order/Telephone Order (MOTO) transactions. For example, in a payment transaction a cardholder provides details over the telephone (either via an automated system or to a person), or via a secure internet portal, the details typically including the card's PAN, the cardholder's name, the card's expiry date, and other security information.

Security of payment transactions is a major concern as there have been many instances of fraudulent transaction with stolen cards/documents or stolen card/document details. Credit/debit cards may also have a CVV or CVC on the magnetic stripe to make it more difficult to replicate a card for fraudulent purposes. The CVC is usually a unique cryptogram, created based on the card data, for example, including the card PAN and expiry date, and a bank's or a personalization bureau's master key, and printed on the card after personalization data is entered on the card. The same principle was subsequently adopted for another CVC sometimes called Card Verification Value 2 (CVV2), which is commonly printed in the signature panel on the back of the card. The CVV2 is used primarily to help secure e-Commerce and Internet or MOTO transactions. This is a second unique cryptogram created from card data and the bank's master key (although this is a different cryptogram as compared with the magnetic stripe CVC). The CVV2 is not present on the magnetic stripe.

Often card issuers issuing DTCs with an SE/EMV install a private key in secure, tamper-resistant memory which is used during communications with a DTD. The private key jointly wraps and identifies that the transaction originated from an interaction with the SE/EMV chip on which the private key is installed and from the DTD with which the transaction is made.

Many DTCs operate with a Personal Identification Number (PIN) code known only to the cardholder(s), which must be kept confidential, and must be entered on secure and certified terminals to verify that the person is the authorized cardholder. Depending on the issuer's configuration, the PIN or the PIN offset may be stored in the SE/EMV chip for offline verification. The PIN or the PIN offset may be stored locally in a secure, tamper resistant memory. Other DTCs may have biometric security means, such as a fingerprint reader.

Most SE/EMV chips operate using a set of standard commands and/or processes (a standard command protocol) called Global Platform Standard (GPS). GPS commands/processes are used when installing a personality (for example, MasterCard, Visa, or Amex), along with personal data related to the customer onto the SE/EMV chip of a DTC. GPS commands are also used by the SE/EMV chip during digital transactions with DTDs. One example is an EMV chip operating with EMV applications embedded in the firmware. Other SE/EMV chips have software (or a software layer) which provides a greater range of operation capabilities for the chip and the DTC. Two example DTCs using SE/EMV chips with a software layer are Java Cards and MULTOS cards.

A software SE/EMV chip is typically provided from a manufacturer with a plurality of containers for different payment schemes. Containers are sometimes referred to as Elementary Load Files (ELFs) or packages, depending on which platform they are operating. For example, a software SE/EMV may be supplied with three containers including Visa, MasterCard and Amex (American Express). Often these containers are in the ROM of the SE/EMV chip. Usually, during personalization, containers representing payment schemes, other than the container which is being used for the card, are disabled or made inactive during the personalization process. Containers provide a range of functions for a DTC, which can be used by applications installed on the DTC. In some implementations, the container is a library of functions or classes (for example, in a JavaCard).

Applications installed on a SE/EMV chip on a DTC may be referred to as applets or cardlets. The applications are typically instantiated in user memory of the SE/EMV chip, for example, in the EEPROM of the chip. Sometimes a payment application will be referred to simply as an application, applet or cardlet. During personalisation of the SE/EMV chip cardholder data (including the cardholder's name, PAN, and other information), and representing the DTC's personality, is written into a payment application.

Some cards have attempted to allow more than one magstripe personality to be installed on a chip (typically, a non-SE/EMV chip) on the card where a user is enabled to select the personality with which the card is to operate. The magstripe personalities are installed “in the field” on the card, duplicated from another card's magstripe or track 2 data. Multiple personalities may include more than one card type from the same payment scheme (for example, a credit card and a debit card from MasterCard), or may include card types in different payments schemes (for example, a Visa debit card and an Amex credit card). Example products include offerings from Plastic, Coin, Final, and Wocket. However, the Plastic solution had operational limitations, and the Wocket solution requires a specific Wocket device. None of these solutions has gained wide market acceptance, and some have now closed or ceased operating.

Another means of conducting transactions is known as a digital wallet. A digital wallet refers to electronic devices and programs used for making payments for purchases digitally, without presenting a physical credit card, debit card, or cash. One type of digital wallet is a device-based digital wallet implemented, for example, on a smartphone. Examples of device based digital wallets include Apple Pay and Samsung Pay. Google Wallet and PayPal provide apps which can operate on smartphones. Device-based digital wallets implemented on NFC enabled devices such as smartphones can be used for contactless Card-Present transactions with suitably configured DTDs. Another type of digital wallet is an internet-based digital wallet which enables a user to add credit card/debit card information allowing the customer to make online purchases. Google Wallet and PayPal are examples of internet-based digital wallets.

Digital wallets may contain a number of different virtual payment cards (for example, Visa, MasterCard, Amex) or card types (credit card, debit card), which may be referred to as Mobile Payment Cards (MPCs) and can be securely stored in a SE/EMV chip of the smartphone. Some digital wallets can also be used to hold other non-payment cards, such as store loyalty cards or gift cards. Collectively, the MPCs and non-payment cards may be referred to a Virtual Cards (VCs), though non-payment cards will not typically be stored in a digital wallet or in the more secure areas of memory on a SE/EMV chip.

During the creation of a DTC a Personalization Bureau (PB) may use scripts to communicate commands to the SE/EMV chip. A script comprises one or more APDUs which are able to effect operations on the SE/EMV chip via authorization provided by a security hierarchy on the chip. Scripts may also be used by Trusted Service Managers (TSMs) and typically have a more complex command set than for a PB script and require encryption for security of the operations because the operations include important and valuable data about the MPCs. The TSM script encryption includes information linking the script to the TSM, the smartphone and the MPC. The encryption therefore protects the script from being used by an unauthorized or incorrect TSM, on an unauthorized or incorrect smartphone, or for an unauthorized or incorrect MPC. TSM scripts have sequence information which must match sequence information retained by the TSM. This helps to ensure the correct script is being used for an operation. Scripts are used only once as a subsequent operation (even if same as a previous operation) will have different sequence information. This is also known as an anti-replay mechanism.

Scripts are not provided externally of a PB or a TSM. Scripts are used to perform certain operations on SE/EMV chips or for MPCs while the SE/EMV chip or the MPC information is in control of the respective PB or TSM. The SE/EMV chip (DTC) and MPCs are provided to a cardholder after scripts have performed operations at the PB or TSM.

Accordingly, many operations available to PBs and TSMs are not available to others. For example, when a user wishes to change the primary MPC on their smartphone, the user must connect with a TSM to allow the TSM to perform required operations with a script to change the primary MPC in the digital wallet, which is then securely communicated back to the user's smartphone. This can be difficult if the user is not in a location where a communication link to the TSM can be established.

### SUMMARY

In one aspect, the present invention provides apparatus on a Digital Transaction Card (DTC), the apparatus including:
a Digital Transaction Processing Unit (DTPU) operable for executing an instruction from a standard command protocol,
wherein the DTC is operable to store one or more scripts, each script including one or more instructions from the standard command protocol, the DTC further operable to cause the DTPU to execute the one or more instructions.

In another aspect, the present invention provides a method for operating apparatus on a Digital Transaction Card (DTC), the apparatus including:
a Digital Transaction Processing Unit (DTPU) operable for executing an instruction from a standard command protocol,
wherein the DTC is operable to store one or more scripts, each script including one or more instructions from the standard command protocol, the DTC further operable to cause the DTPU to execute the one or more instructions,
   the method including:
operating the apparatus to cause the DTPU to execute the one or more instructions.

In a further aspect, the present invention provides a system for digital transactions, the system including:
apparatus on a Digital Transaction Card (DTC) including:
   a Digital Transaction Processing Unit (DTPU) operable for executing an instruction from a standard command protocol,
   wherein the DTC is operable to store one or more scripts, each script including one or more instructions from the standard command protocol, the DTC further operable to cause the DTPU to execute the one or more instructions; and
an off-card entity operable to provide at least one script to the DTC.

In one aspect, the present invention provides apparatus on a Digital Transaction Card (DTC), the apparatus including:
a Digital Transaction Processing Unit (DTPU) operable for executing an instruction from a standard command protocol,
wherein the DTC is operable to store one or more scripts, each script including one or more instructions from the standard command protocol, the DTC further operable to cause the DTPU to execute the one or more instructions, and
wherein the apparatus includes software operable to store one or more software packages, at least one of the one or more software packages representing a Virtual Card Profile (VCP), the apparatus operable with the VCP to cause the DTC to adopt the personality associated with the VCP.

In another aspect, the present invention provides a method for operating apparatus on a Digital Transaction Card (DTC), the apparatus including:
a Digital Transaction Processing Unit (DTPU) operable for executing an instruction from a standard command protocol,
wherein the DTC is operable to store one or more scripts, each script including one or more instructions from the standard command protocol, the DTC further operable to cause the DTPU to execute the one or more instructions, and
wherein the apparatus includes software operable to store one or more software packages, at least one of the one or more software packages representing a Virtual Card Profile (VCP), the apparatus operable with the VCP to cause the DTC to adopt the personality associated with the VCP,
   the method including:
operating the apparatus to cause the DTPU to execute the one or more instructions to cause the DTC to adopt the personality associated with the VCP.

In a further aspect, the present invention provides a system for digital transactions, the system including:
apparatus on a Digital Transaction Card (DTC) including:
   a Digital Transaction Processing Unit (DTPU) operable for executing an instruction from a standard command protocol,
   wherein the DTC is operable to store one or more scripts, each script including one or more instructions from the standard command protocol, the DTC further operable to cause the DTPU to execute the one or more instructions, and
   wherein the apparatus includes software operable to store one or more software packages, at least one of the one or more software packages representing a Virtual Card Profile (VCP), the apparatus operable with the VCP to cause the DTC to adopt the personality associated with the VCP; and
an off-card entity operable to provide at least one script to the DTC and operable to provide at least one VCP to the DTC.

In one aspect, the present invention provides a method including receiving, from an issuing authority, a DTC configured to operate in accordance with any one or more of the statements above.

In one other aspect, the present invention provides a method including issuing, by an issuing authority, a DTC configured to operate in accordance with any one or more of the statements above.

In a further aspect, the present invention provides a method including receiving, from an issuing authority, a DTC configured to operate in accordance with the method of any one or more of the statements above.

In yet a further aspect, the present invention provides a method including issuing, by an issuing authority, a DTC configured to operate in accordance with the method of any one or more of the statements above.

In another aspect, the present invention provides a method including issuing, by an issuing authority, operating code, including software and/or firmware, to a Digital Transaction Card (DTC) to enable the DTC to operate in accordance with any one or more of the statements above.

In yet another aspect, the present invention provides a method including issuing, by an issuing authority, operating code, including software and/or firmware, to a Digital Transaction Card (DTC) to enable the DTC to operate in accordance with the method of any one or more of the statements above.

### SUMMARY OF SOME OPTIONAL EMBODIMENTS

For consistency, in this specification the following terms may be used for describing some embodiments of the present invention:
Digital Transaction Processing Unit (DTPU): An integrated circuit chip on a DTC which is configured to comply with one or more Global Platform Standards (GPS) specifications and/or one or more EMVCo standards specifications. Such chips are sometimes referred to as Secure Elements (SEs) or EMV chips. In a DTC with a form factor of a traditional credit or debit card a DTPU is operable for both contact transactions and contactless transactions. In a wearable device, having a form factor such as a ring or a watch, a DTPU is operable is operable only for contactless transactions because such a device cannot be inserted or dipped into a DTD. Although it is contemplated that a DTPU for the present invention be suitable for either or both payment and non-payment operations, the description of the invention focuses mostly on embodiments for payment operations.
In some embodiments, the DTPU is a secure element or EMV chip, similar to those used in credit or debit cards, and adapted to allow operations as described for the present invention.
Payment scheme: In embodiments, the DTPU of the present invention is configured to operate with one or more payment schemes. Example payment schemes include Visa, MasterCard, Amex, and there are many others. Payment schemes are controlled on a DTC by a bank or other kind of issuing authority.
Micro Controller Unit (MCU): In embodiments, the DTC of the present invention may have a Micro Controller Unit (MCU) which controls various components of the DTC, such as a user interface, buttons of the user interface, a graphical display of the user interface, a Bluetooth chip, a secure memory, and other components. In embodiments, the MCU may also control select operations of the DTPU.
Script: In some embodiments, select functions available on the DTPU are operated by means of scripts. A script includes one or more GP commands, wherein each command effects a function of the DTPU. In order to access functions within the DTPU security hierarchy, a command is signed with a cryptographic key which is associated with a node (ISD or SSD) in the hierarchy, the signing of the command allows the command to effect the functions under the associated node.
Container: Sometimes Elementary Load Files (ELFs) or packages are referred to as containers. It will be recognised that the terminology is interchangeable and should be applied as required for the technology used for implementing embodiments of the present invention. For example, if the embodiment is implemented on a JavaCard, the DTPU hosts packages for providing basic or common functionality to transaction applications instantiated under a payment scheme. The term container is intended to be a generalised reference to ELFs and packages.
Personality: In embodiments, a DTPU may have one or more personalities, or digital transaction personalities, wherein each personality is associated with at least a PAN or another unique identifier. The personality may also be associated with a cardholder name, expiry date, a CVV and various other data, however, the primary association of each personality is its PAN or its unique identifier. For payment transaction personalities, such as credit or debit cards, the PAN is always numeric. Other types of transaction cards or documents may have unique identifiers which are alphanumeric.
Digital Transaction Card (DTC): A transaction card, such as a credit card or debit card, including an integrated circuit chip, for example, a DTPU, for effecting digital transactions with DTD. Some DTCs may include both an integrated circuit chip and a magnetic stripe for holding information. In this specification a DTC also includes devices that do not have a traditional card form (such as a credit or debit card form). In various embodiments, a DTC includes a wearable device, such as a ring or a bracelet, devices for mounting to vehicles, or any other form of device capable of having an integrated circuit chip, as described in the previous paragraph, incorporated therein.
Secure memory: Memory on a DTC outside of a DTPU. The secure memory may be used for storing one or more keys, for example, one or more keys each associated with a security domain, such as an SSD, on the DTPU. The secure memory may be located on a Micro Controller Unit (MCU), or on another chip controlled by a MCU on the DTC;
Data Assistance Device (DAD): A device separate from the DTC, which can be operated to effect communications between the DTC, via the DAD, to a remote agent, such as a provisioning agent. For example, the DAD may broker communication between a DTC and a Trusted Service Manager (TSM). The DAD may also be used for effecting operations on the DTC, without establishing a communication link to a remote agent. An example DAD is a smartphone, which can link to the DTC, for example, by Bluetooth/Bluetooth Low Energy (BLE) or by Near Field Communication (NFC), and can establish a communication channel to a remote agent, for example, via the internet. Other devices may operate as a DAD, such as a Personal Computer (PC) or a tablet computing device. It is also contemplated that a DTD could be operated as a DAD, though a DTD or its software will likely require modification for such purpose.
Lock/unlock: The GPS commands for, respectively, deactivating/activating applications in the DTPU, such that, when active (unlocked), an application can be accessed by a DTD for a digital transaction, and such that, when inactive (locked), an application cannot be accessed by a DTD. Other terms used include activating/inactivating, blocking/unblocking, activating/blocking and enabling/disabling. The terms lock/unlock will be preferred in this specification. The terms may also refer to the state of an application, that is, being in either a lock(ed) state or unlock(ed) state. Sometimes, instead of specifying that one or more transaction applications associated with a personality have each been locked/unlocked (as appropriate in the context), the personality will be described as being locked/unlocked (as appropriate in the context).
Off-card entity: An entity in a card issuing and payment network. Some off-card entities have a function or set of functions required for issuing DTCs, virtual cards for mobile payments devices (for example, smartphones), or for otherwise provisioning to DTCs and mobile payment devices. An example off-card entity is a Trusted Service Manager (TSM), which is traditionally responsible for providing virtual cards to smartphones. Other off-card entities include Wallet Service Providers (WSPs), Token Service Providers (TSPs), Acquirers (which process digital transactions), Card Personalization Bureaus (Persos), and Financial Institutions (which establish accounts for the payment applications). Some off-card entities may provide a number of different functions, including those traditionally assigned to other off-card entities.
Virtual Card Profile (VCP): A virtual card is a soft card (or software card), traditionally issued, for example, by a TSM for use on a mobile payment device, such as a smartphone. Virtual cards are operable only for contactless payments with a limited range of suitable digital transaction devices.
Embodiments of the present invention use a Virtual Card Profile (VCP), which is similar to a virtual card, but is operable for both contactless and contact transactions, and is installable on a DTPU (for example, an EMV chip) on a DTC.
Other terms which may be used in this specification instead of MVC include: Modified Virtual Card Profile (MVCP), Modified Mobile Payment Card (MMPC), and Modified Virtual Card (MVC). Some MVCs are suitable for payment transactions, including MMPCs, and some for non-payment transactions, such as personal ID, age verification and other non-payment functions.

A VCP can be generated by a TSM, and a personality associated with the VCP is what a DTC adopts when the VCP is selected as the primary card profile for the DTC. A personality may also be associated with other implementations of logical cards on a DTC, other than VCPs as generated by a TSM. For example, the logical card profile may be generated by a non-TSM issuer and loaded onto a DTC for use in establishing an associated card personality on the DTC.

A VCP is different from a Mobile Payment Card (MPC), which can work only on a mobile device, such as a mobile phone. A MPC is suitable for contactless payments only. In embodiments, a VCP is adapted to be suitable for contact payments and contactless payments.

Sometimes hardware in a DTC may be referred to as a hardware layer, and software in a DTC may be referred to as a software layer. Similarly, firmware in a DTC may be referred to as a firmware layer. It will be understood that the terms software layer, hardware layer and/or firmware layer are references to logical layers and such layers are not necessarily represented by physical layers in a DTC. It will also be understood that in embodiments the software (or software layer) controls operations in the hardware (or hardware layer), or the software (or software layer) controls operations in the firmware (or firmware layer), and that the software (or software layer) typically has lower permissions than the hardware (or hardware layer) in a security hierarchy.

In some embodiments, the apparatus is operable to store at least one script, the script when executed, operable with at least one of the one or more software packages to cause the DTC to operate in accordance with at least one command from the standard command protocol. In various embodiments, the script is issued by an authenticated third-party, for example, a Trusted Service Manager (TSM).

In some embodiments, the DTC is adapted to securely store keys (or key pairs) for ISD and/or SSD authentication/authorization, or for other authentication/authorization and/or other appropriate security rights. A key or key pair can operate in cooperation with a script to provide the required authentication for a security hierarchy, for example, to authorize operations on the DTPU (EMV). In some instances, a key or key pair could provide a higher-level security authorization/authentication than allowed for within the script (which may have its own security keys or key pairs). In embodiments, keys or key pairs can be stored in a secure element. The secure element can be located on a chip on the DTC external to the DTPU (EMV), for example, on a chip including a Micro Controller Unit (MCU). In other embodiments, the secure element could be located on the DTPU (EMV chip) itself.

In other embodiments, the method includes operating at least one script with at least one of the one or more software packages to cause the DTC to operate in accordance with at least one command from the standard command protocol.

In various embodiments, the at least one application for executing one or more instructions from the standard command protocol is a firmware application or firmware code.

In embodiments, the DTC is configured with abilities to emulate selected facilities of a TSM, such as the ability to change which card profile is the primary or operating card personality. Ordinarily, a TSM would be used to make such changes with one or more secure scripts and then transfer the changed operating state to a mobile device, such as a smartphone. In the present embodiment, such facilities for changing operating personality are located on the DTC itself, thus the changes can be performed remotely from a TSM and without the DTC needing to be in communication with a TSM to effect such changes.

In yet other embodiments, the system includes a script distribution infrastructure, including at least one script distribution device operable to provide at least one script to the DTC. In some embodiments, at least one of the VCP distribution devices is also operable as a script distribution device.

In embodiments, the DTC includes a Digital Transaction Processing Unit (DTPU), the DTPU operating in accordance with a standard command protocol. In some embodiments, the DTPU includes the hardware and the software.

In other embodiments, the DTC includes a Micro Controller Unit (MCU). The MCU may be separate from the DTPU, and configured to operate with the DTPU. In yet other embodiments, the software layer is located in part or entirely on the MCU. In further embodiments, the MCU is configured to emulate at least some functions of a digital transaction device, such as an Automatic Teller Machine (ATM), a Point Of Sale (POS) terminal, or an Electronic Funds Transfer at Point Of Sale (EFTPOS) terminal.

In some embodiments, the at least one script includes cryptographic data to enable operations requiring cryptographic function to operate. As such the script contains both one or more commands and cryptographic data. The cryptographic data may be in the form of key pairs, including public and private keys (asymmetric keys).

In embodiments, the cryptographic data may include multiple sets of keys, for example, a first set of keys may allow the script and instruction package to securely communicate with the DTPU, and a second set of keys are transmitted via the secure communication to allow for operations on the DTPU requiring the second set of keys. Further, the key pairs may represent a hierarchical security structure with some key pairs allowing authentication and greater access to secure data or secure processes than other key pairs.

In some embodiments, a security hierarchy is implemented wherein a TSM has the highest security permissions in the hierarchy allowing the TSM to create scripts and determine which entities lower in the hierarchy are permitted to use the scripts. The TSM can also determine what the permitted entities lower in the hierarchy can do with the scripts. In one example embodiment, the TSM creates and distributes scripts to permitted entities, one such entity may be a cardholder's smartphone, which can download the scripts from the TSM, however, the smartphone does not have permission to see the contents of the scripts or perform any operations with the scripts, the smartphone is only permitted to forward the scripts to a designated DTC (typically, also belonging to the cardholder). The scripts are loaded to the MCU of the DTC, but the MCU can send certain scripts that include functions, such as locking/unlocking VCPs (the profiles may be identified through their AIDs). The MCU (when emulating a digital transaction device, such as an ATM or POS/EFTPOS terminal) also has permission to pass some information (files, applications, keys and other data) to the DTPU. The DTPU may then perform permitted operations according to the information provided by the script through the MCU. The script could also allow the MCU to pass information to the DTPU not contained in the script, but permitted by the script. By using such hierarchies, ultimate control of the use of scripts can be retained by the TSM even when the scripts are being used outside of the TSM. Further, the TSM can allow higher security operations and information in scripts to be accessed by an entity or device which is not in direct communication with the TSM, such as a DTPU, after the script and its contents have passed through, for example, a smartphone and an MCU.

It will be appreciated that the above example of scripts being created by a TSM and passed through to a smartphone, MCU thence to a DTPU, is illustrative, and there are various other paths that scripts could be sent through to reach a DTPU or to effect operations on a DTPU. The permissions can be determined and implemented by the TSM by appropriate selection of asymmetric keys (public key/private key pairs), wherein the script may contain operations, operation permissions and/or data encrypted with a public key, the private key of which is held, for example, by the DTPU. Public and private key pairs used in such ways are sometimes referred to as a Public Key Infrastructure (PKI).

A script may also use session keys, which are generated for a one time use or for limited time use. For example, a locking operation is permitted by a key pair, but after the locking operation is executed, the key pair becomes redundant and can no longer be used to permit a same operation (or any other operation). In other embodiments, a script could include Secure Card Protocol (SCP).

In other embodiments, a script can be used for authentication and may use mutual authentication, data ciphering, and data MACing. The mutual authentication can use a generated random value based on the targeted AID, an authentications counter (also known as an anti-replay counter), MAC using SSD keys and a constant defined by GPS.

Scripts are required by standard command protocols, such as Global Platform Standards (GPS), to conform with sequence counting procedures (for example, an authentications counter). As such, for compliance the sequence count in scripts may be required to be in synchrony with a sequence count operating on the DTPU and a sequence count retained by a Trusted Service Manager (TSM). Once a script with a particular sequence number is used, that sequence number cannot be used again and the script is exhausted. As each script is exhausted after operating with at least one of the one or more software packages to cause the DTC to operate in accordance with at least one command from the standard command protocol, it is necessary to have multiple scripts to allow for multiple such operations. Further, it will be appreciated that the multiple scripts will be exhausted after a same multiple of operations. In some embodiments, the scripts can be refreshed by supplying a new set of scripts to the DTC.

In one example embodiment, the MCU hosts a predefined total number of scripts (for example, 10 scripts) generated with increasing counter values, each time a script is used it is disabled by the MCU (an exhausted script). When the number of remaining unused (non-exhausted) scripts is a predefined percentage of the total number (for example, 5 scripts), the DTC can be configured to automatically contact a TSM during a next transaction to obtain fresh scripts. For example, during a payment transaction with an EFTPOS terminal the DTC attempts to communicate with the TSM through the EFFTPOS terminal to obtain scripts via the EFTPOS terminal. Scripts could also be refreshed via other types of terminal, such as ATMs, or could be refreshed via a smartphone if there is a facility to communicably link the smartphone with the DTC.

In another embodiment, the DTC can be configured to reset the script counter (authentication counter) to a value which allows the script to be reused. Typically, the reset value will be zero (0). To avoid risk of losing synchronization, the sequence counter is reset at the end of each script by using a PUT KEY Command. The PUT KEY command replaces the existing keyset a with an identical keyset with same key values. In one example implementation, the GPS PUT_KEY command resets the SSD counter to 0.

In embodiments, the at least one script is provided by a Trusted Service Manager (TSM). The scripts may be distributed by various means, such as an existing payment infrastructure including digital transaction devices, for example, Automatic Teller Machines (ATMs), and Point Of Sale (POS)/Electronic Funds Transfer at Point Of Sale (EFTPOS) terminals. The digital transaction devices may be adapted to transfer scripts to a DTC when a DTC comes into physical contact or wireless communication contact with such a device, for example, during a payment transaction.

In other embodiments, the scripts may be distributed to a DTC from a computing device (including Personal Computers (PCs), tablet computers and other kinds of computing devices), which is connected to the internet and can communicate with a DTC with a suitable peripheral device. In yet another embodiment, the scripts could be distributed to the DTC via a Data Assistance Device (DAD), such as a smartphone, a smartwatch, a fob, a smart ring and any other suitable device with computing capability and connection to a network, such as the internet for communicating with a TSM. In embodiments, the DAD and DTC are suitably configured to allow intercommunication, for example, by Bluetooth™ or other suitable communication protocols.

In some embodiments, the apparatus is in the DTPU. In other embodiments, the apparatus comprises the DTPU and the MCU.

In various embodiments, the DTC includes a user interface including a display (Graphical User Interface (GUI)) and buttons for operating the DTC. The display may be an Electronic Paper Display (EPD). The buttons may include an off/on button, scrolling buttons and a selection button.

In other embodiments, the one or more software packages are applets. The applets may include Java applets in a suitable container in the software layer. It will be understood that, as Java applets, a software package, when operated, becomes an instance of the associated applet in the container. In other embodiments, the software layer may use a MULTOS operating system and the software packages will be adapted to work with that operating system. Scripts can be adapted to work with the various embodiments of software operating systems, such as Java Card and MULTOS.

In some embodiments, a script and an applet are operable to reorder two or more VCPs stored in the DTPU (including parts of the virtual cards stored in the DTPU secure memory) to cause a selected card to be a primary card operating on the DTPU. In some such embodiments, the applet used for reordering is a PSE/PPSE applet. In embodiments, the user interface of the DTC is operable to display, highlight and select a card to become the primary card operating on the DTPU. In some embodiments, the primary card is a selected memory location, and in other embodiments the primary card is determined by a pointer to the memory location on the DTPU where the selected card is stored.

In embodiments, the cards associated with each VCP are in the hardware (sometimes referred to as firmware or a firmware layer) of the DTC (embedded in the firmware), and the software packages and scripts are in the software (or software layer). The DTC may include a scheme holder (in some example embodiments, implemented as an applet) adapted to store a card (a VCP) and PAN. It will be appreciated that a “physical” PAN that is installed into a scheme holder would lock the DTC (the DTPU), such that no further VCPs or cards schemes could be installed.

In embodiments, scripts and applets are operated to disable, deactivate or otherwise cause one or more of two or more VCPs to be “not seen” by a digital transaction device when operating with the DTC (for example, making a payment with the DTC at an EFTPOS device). In some such embodiments, the applet used for disabling/deactivation or enabling/activation is a PSE/PPSE applet. As such, when using Explicit Selection process, a PSE process, or a PPSE process, the used process will return only the Application ID (AID) associated with a selected VCP, thus causing the DTC to adopt the personality of the card profile associated with the VCP for subsequent transactions.

In some embodiments, exhaustion for a script occurs after an activation and/or deactivation, and reordering operation. In other embodiments, exhaustion for a script occurs after an activation and/or deactivation operation alone, or exhaustion of the script occurs after a reordering operation alone. In yet other embodiments, exhaustion of a script may include a larger number of operations of different types than only activation and/or deactivation and reordering operations.

In other embodiments, scripts and applets are operated to deactivate any and all card profiles (may be just one primary card profile) on a DTC. This can be used for disabling a DTC during a detected fraudulent transaction. In such operations, a payment or issuing network entity, for example a TSM, is authorized to enact a disabling operation when a fraudulent transaction is detected or suspected by an acquirer. Similarly, a DTC could be reactivated by the TSM in the circumstance that the DTC has been verified by an acquirer as not being fraudulently used.

In some embodiments, scripts can control the operations of, modify, or instantiate with appropriate parameters the PSE or PPSE to return only a selected card profile during an application selection process. It will be understood that presently cards (including Java Cards) operate with standard PSE/PPSEs. In some such embodiments, a modified PSE/PPSE can be installed, and in further embodiments, the PSE and PPSE are implemented as applets on a Java Card. In an example implementation, the script provides authentication codes to the ISD, which, when confirmed, allows the script to unlock a selected application, for example, an application associated with a Visa credit card (a first scheme) VCP, and further allows the script to lock other applications (non-selected applications), for example, applications associated with a MasterCard debit card (a second scheme) VCP, and an Amex credit card (a third scheme) VCP. The script is then used to update the PSE/PPSE (after appropriate authentication) to only return the Visa credit card (the first scheme) VCP in an application selection process. In another example implementation, the script updates the PSE/PPSE to allow the PSE/PPSE to lock and unlock the required applications depending upon which has been selected to be the active card.

In embodiments, scripts are stored on and operated by the MCU, and applets in the software layer, along with applications in the hardware (firmware) layer are located on and operated by the DTPU. In other embodiments, the scripts are stored on the MCU and pushed to the DTPU when a script operation is required.

In some embodiments, scripts are configured to operate with VCPs, as generated, for example, by a TSM. It will be understood that such VCPs are at least similar to VCPs a TSM can generate for use on a smartphone in a digital wallet. In other embodiments, scripts are configured to operate with card profiles similar to those provided by an issuer when personalizing a blank card. In this way, scripts can be implemented to work with a range of files representing card personalities to be adopted by a DTC.

In some other embodiments, the DTC can be implemented with a single PIN, which operates for all VCPs loaded on the DTC.

In various embodiments, an EMV (or more generally a DTPU) may have a Global Platform configuration, with assignable lock privileges. The EMV (DTPU) may also have a preload and storage capacity, capable of functioning as required.

In some embodiments, an example script may have ADPUs for the following functions: SELECT SSD, INITIALIZE UPDATE, EXTERNAL AUTHENTICATE, SET ACTIVE APPLICATION and (optionally) GET DATA—ACTIVATED APPLICATION.

### BRIEF DESCRIPTION OF THE DRAWINGS

At least one embodiment of the invention will be described with reference to the following, non-limiting illustrations representing the at least one embodiment of the present invention, in which:

FIG. 1 is a diagrammatic representation of an example security hierarchy in accordance with an embodiment of the present invention;

FIG. 2 is a diagrammatic representation of an example implementation of scripts on a DTC in accordance with an embodiment of the present invention;

FIG. 3 is sequence diagram showing operations between an MCU and DTPU (EMV) in accordance with an embodiment of the present invention;

FIG. 4 is sequence diagram showing operations between an MCU and DTPU (EMV) in accordance with an embodiment of the present invention;

FIG. 5 is a diagrammatic representation of a communication pathway between a TSM and a DTC for delivering a script to the DTC from the TSM in accordance with an embodiment of the present invention;

FIG. 6 is a diagrammatic representation of a payment and DTC/virtual card issuing network) in accordance with an embodiment of the present invention;

FIG. 7 is a diagrammatic representation of an example operation for loading virtual cards onto a DTC in accordance with an embodiment of the present invention;

FIG. 7A is a diagrammatic representation of an example operation for loading virtual cards onto a DTC in accordance with an embodiment of the present invention, which differs from that shown in FIG. 7;

FIG. 8 is a diagrammatic representation of an example operation for loading virtual cards onto a DTC in accordance with an embodiment of the present invention different from that shown in FIG. 7;

FIG. 9 is a diagrammatic representation of an example operation of a DTC having its personality changed by a user.

FIG. 10 is a diagrammatic representation of an example implementation of scripts on a DTC in accordance with an embodiment of the present invention;

FIG. 11 is a diagrammatic representation of a method for generating session keys;

FIG. 12 is a diagrammatic representation of an example implementation using a single script on a DTC in accordance with an embodiment of the present invention;

FIG. 13 is a diagrammatic representation of an example security hierarchy in accordance with an embodiment of the present invention;

FIG. 14 is sequence diagram showing operations between an MCU and DTPU (EMV) in accordance with an embodiment of the present invention;

FIG. 15 is a diagrammatic representation of an example security hierarchy in accordance with an embodiment of the present invention;

FIG. 16 is sequence diagram showing operations between an MCU and DTPU (EMV) in accordance with an embodiment of the present invention;

FIG. 17 is a diagrammatic representation of an example security hierarchy in accordance with an embodiment of the present invention;

FIG. 18 is sequence diagram showing operations between an MCU and DTPU (EMV) in accordance with an embodiment of the present invention;

FIG. 19 is a diagrammatic representation of an example security hierarchy in accordance with an embodiment of the present invention;

FIG. 20 is sequence diagram showing operations between an MCU and DTPU (EMV) in accordance with an embodiment of the present invention; and,

FIG. 21 is a sequence diagram showing operations for replenishing scripts on a DTC, in accordance with an embodiment of the present invention.

### DETAILED DESCRIPTION

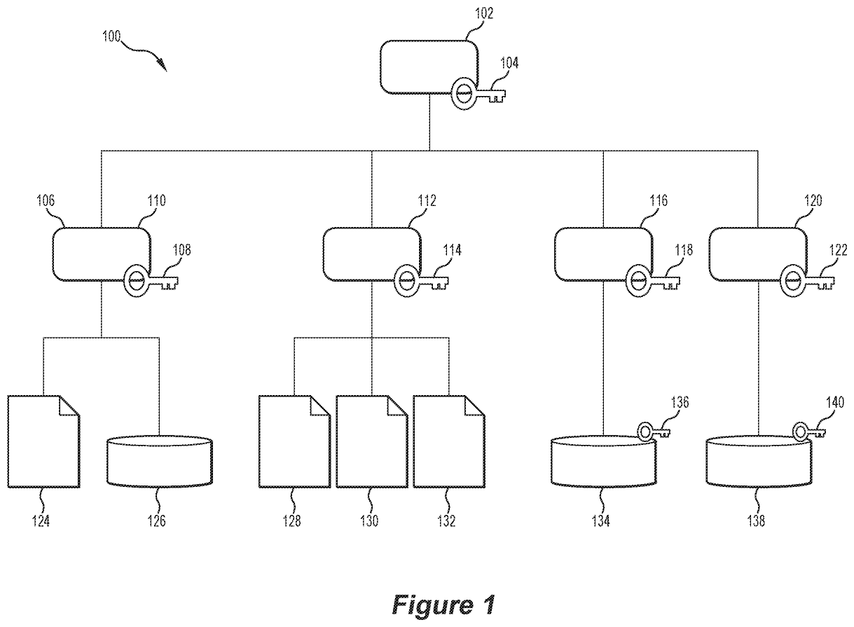

Referring to FIG. 1, an example security hierarchy 100 for a secure element in a DTPU is shown with the top of the hierarchy being the Issuer Security Domain (ISD) 102. The ISD is the owner of the secure element in a DTPU (for example, an EMV chip) on a DTC, and is responsible for content management on the DTC and assigning privileges. The owner of the secure element may be a card issuer, or another authorized third-party managing the secure element as a service. Alternatively, management of the secure element could be the responsibility of a customer (the cardholder), if given the appropriate security authorization and means to operate with that level of responsibility. DTC content management includes functions: LOAD packages, INSTALL applications, and DELETE applications and packages.

The hierarchy uses a Supplementary Security Domain (SSD) 110, which is managed by a third-party for the purposes of changing the personality with which the DTC operates. The third-party personality manager installs an application on the DTC for controlling some operations of the DTC, including operation of the PSE/PPSE and the DTPU (in particular, the secure element of the DTPU). The ability to operate the SSD is provided through the appropriate authorization 108, for example, by provision of keys. The third-party personality manager SSD 110 may also have authority for Global Locking 106.

The third-party personality manager SSD has control of one or more packages 124, which may be implemented as one or more applets. The packages, when called, instantiate one or more corresponding instances 126. In one example, there may be one package for a custom PPSE and another package for a custom PSE, instantiating, respectively, as a custom PPSE instance and a custom PSE instance. With this control under the SSD, the third-party personality manager is able to cause the PPSE and PSE applications to perform operations on the PSE/PPSE of the DTC. In one embodiment, the PPSE gets the Global Lock privilege allowing the LOCKing and UNLOCKing of other applications on the secure element.

According to GPS, the Global Lock privilege provides the right to initiate the locking and unlocking of any Application on the card, independent of its Security Domain association and hierarchy. It also provides the capability to restrict the Card Content Management functionality of OPEN. This allows a single entity on the Secure Element to implement the lock/unlock mechanisms. An off-card entity requiring the lock or unlock functions should be authenticated using the appropriate secure channel.

In one example implementation of a standard command protocol (or a general card and issuing/payment network operation protocol), the Global Platform Standards (GPS), mapping guidelines define which global platform privileges are recommended or optionally supported by the ISD and SSD or applications (for example, applets). In example implementation, each EMV chip can differ, with some EMV chips supporting an extended version of mapping guidelines (called “Mapping Guidelines Plus”). Some implementations of the GPS allow the global lock privilege to be assigned to applications. In embodiments of the present invention, software packages (applications), such as applets, could therefore contain global lock privilege. In other embodiments, global lock privilege could be assigned to a script (or a number of scripts). With such global lock privilege assignment, applets or scripts, when operated, may be enabled to perform LOCK/UNLOCK operations, and other operations requiring a high-level authorization according to the GPS security hierarchy.

The hierarchy 100 also includes an SSD utility 112, with appropriate authority 114 to operate a number of packages relating to various card profiles (VCPs) and their associated payment schemes. In this example embodiment, a first package 128 holds information for a Visa card profile, a second package 130 holds information for a MasterCard profile, and a third package 132 holds information for an Amex profile.

The hierarchy 100 includes two example bank SSDs 116, 120, with associated security 118, 122. The bank SSDs are each associated with a bank hosting applications for the VCPs 128, 130, and 132. In this example, the first bank SSD 116 is associated with the Visa application, and instantiates a Visa instance 134; the second bank SSD 120 is associated with the MasterCard application and instantiates a MasterCard instance 138. The keysets 136, 140 from these bank SSDs allows personalization of the banking applications. The owners of the bank SSDs 116, 120 are responsible for generating personalization scripts for the banking profile data.

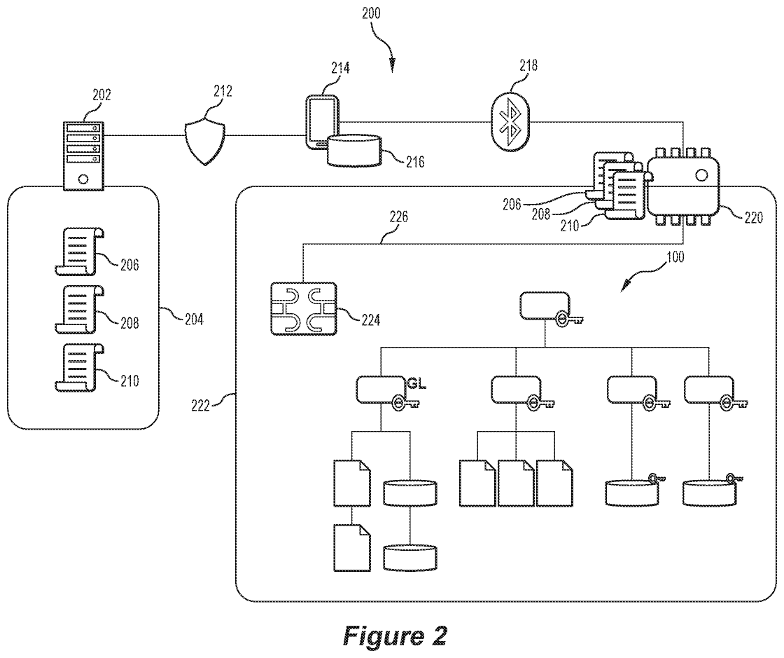

As shown in FIG. 2, the security hierarchy 100 is implemented in the secure element of a DTPU 224 (an EMV chip) on a DTC 222. The DTC also has an external processing chip, a Micro Controller Unit (MCU) 220. The MCU is loaded with scripts 206, 208, and 210, which are generated 204 by a Trusted Service Manager 202 and sent through a Secure Socket Layer (SSL) 212 over the internet to a cardholder's mobile device (smartphone) 214. The smartphone 214 is loaded with an app 216 configured to securely accept the scripts generated by the TSM and to connect with the DTC 222 via Bluetooth 218, and to send the scripts via the Bluetooth link to the MCU 220.

With the scripts 206, 208, and 210 loaded into the MCU the cardholder can perform operations via an interface on the DTC (not shown in FIG. 2). The interface may include buttons operable to allow the cardholder to select a VCP to become the operating personality of the DTC, and a display showing the cardholder which personality has been selected and is operating. The scripts enable authentication by the MCU of one or more operations for the DTC, including operations in accordance with the security hierarchy 100. As scripts require a valid authentication to be executed by the secure element of the DTPU (EMV), and the information in the script is not confidential, ciphering the data is not required.

In an embodiment, each successful authentication operation disables (exhausts) the script used for that authentication. When a predefined number of scripts have been exhausted, or a predefined number of scripts remain unexhausted, and when the DTC is connected with the smartphone 214, it can notify the smartphone which scripts have been exhausted, and the smartphone (via the app 216) can request a new batch of scripts from the TSM. In this way, the scripts can remain synchronized between those on the DTC and those copies of scripts (or records of the scripts) retained by the TSM.

Another means by which to retain synchronization is to reset the sequence counter after a script has been used for a successful authentication or another operation, which would otherwise exhaust the script. Using GPS, the sequence counter can be reset using a PUT_KEY command, which replaces the existing keyset with an identical keyset having the same key values. This results in the script being valid for further use without immediate replenishment from the TSM. The PUT_KEY command requires authentication to the SSD using the highest security level available, that is, AUTHentication+ENCryption+MAC. There are two types of script for this option: the selection update with security level AUTH, and the update keys script with AUTH+ENC+MAC security level.

Ultimately, when possible, an update from the TSM will still be required to provide a key update with new values. Updating key is a security requirement, and must be done regularly, or the security may be compromised. However, the update can occur as a background task when the DTC is connected with the smartphone.

Although embodiments described in this specification exemplify a smartphone as means to communicate data, including scripts, between a TSM and the DTC, other means may be suitable for this function, including computer tablets, smartwatches (and other wearable mobile communication devices), PCs, laptops and other devices which can be securely connected to a network for secure communication between the device and the TSM, and which can also be connected to the DTC via a suitable communication protocol such as Bluetooth. Further, the TSM and DTC can connect for secure data communication therebetween using digital transaction devices, such as ATMs and POS/EFTPOS terminals when the DTC is used for transactions with those types of device.

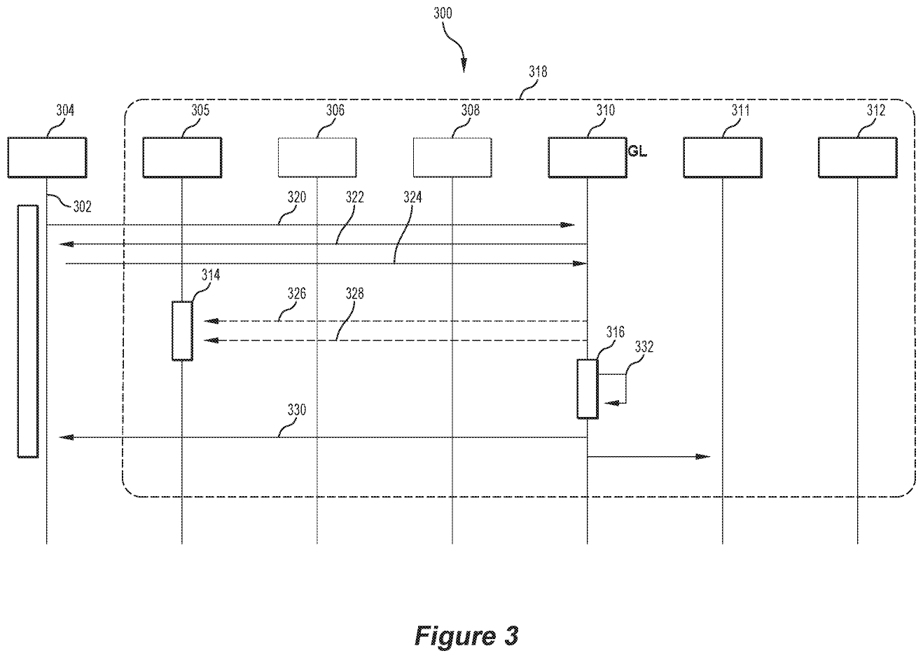

FIG. 3 is a sequence diagram 300 showing an example of how an MCU 304 can operate with scripts to establish a Secure Channel Protocol (in this example, SCP02) 302 for communication with an EMV secure element 318 to effect changes in accordance with the security hierarchy having the highest authority under the ISD 306, such as a change in personality of the EMV by enabling/disabling appropriate applications representing VCPs on the EMV.

The cardholder uses the DTC interface to select a card (for example, a Visa card) which is to be the new operating personality of the DTC to replace the presently operating personality (for example, an Amex card). The MCU launches the selection process by authentication 320, 322 to the SSD 308 through the PSE/PPSE application 310 using a third-party SSD keys (the third-party being one designated to manage personality changes on the DTC). The MCU then sends a Set Active Application 324 command to the PPSE (for contactless card transactions)—the active application will be the Visa application. The PPSE operates to check the LOCK/UNLOCK state of the applications, LOCKS 326 the application to be deactivated (the Amex card application) using GPS APIs 314, UNLOCKS 328 the application to be activated (the Visa card application), then UPDATES FCI 332 of the PSE/PPSE FCI 316 to accord with the AID of the activated application. The PPSE updates the PSE payment directory. Finally, an OK 330 is sent to the MCU. When next used, the DTC's EMV will have the personality of the Visa card operating and will use the appropriate Visa banking applet 312 in a payment operation.

In the example depicted in FIG. 3, a script used in the operations contains Application Protocol Data Unit (ADPU) commands for authentication using a keyset from a third-party personality management SSD. The script command content may include, for example:
SELECT PPSE;
INITIALIZE UPDATE;
EXTERNAL AUTHENTICATE; and
SET ACTIVE APPLICATION
   commands.

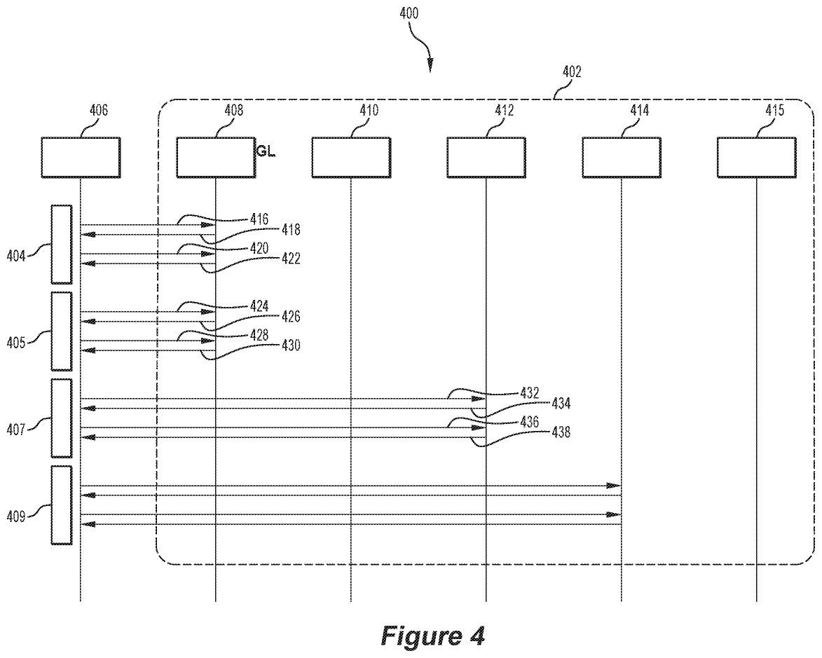

FIG. 4 is a sequence diagram showing another possible implementation of activating/deactivating (unlocking/locking) applications in an EMV secure element 402 on a DTC using scripts for managing authentication in accordance with the security hierarchy (including the ISD 408 and SSD 410). In this example implementation, the ISD 408 has the Global Lock (GL) authority. As with the example depicted in FIG. 3, the cardholder selects a card profile desired for the DTC via the DTC interface (buttons and display). In this example, the cardholder may desire to change the operating personality of the DTC from a MasterCard credit card to the cardholder's bank's debit card. The cardholder's selection causes the MCU 406 to launch a selection process by establishing a secure channel 404 and commences authentication 416 with the ISD 408, and, if successful, receiving an OK message 420 back from the ISD. Other secure channels 405, 407, and 409 are established during the selection process as needed for secure communication between the MCU and EMV. The MCU can then check the LOCK/UNLOCK status of the applications in the DTPU, and select which scripts should be run to effect the change desired by the cardholder. The MCU runs a suitable script with the LOCK command 420 to deactivate the MasterCard credit card, receiving an OK indicator 422 from the ISD 408. The MCU then performs another authentication with the ISD 424, receiving an OK 426, before running another suitable script with the UNLOCK command 428 to activate the cardholder's bank's debit card and receiving an OK indicator 430.

Following the UNLOCKING/LOCKING commands, the MCU selects the next available authentication script and runs this script for authentication 432, 434 before sending a SELECT PPSE command to the PPSE 412 to update 436, 438 the FCI of the PPSE according to the AID of the selected application (the cardholder's bank's debit card application). In a separate action, the MCU can update the PSE 414 payment directory with the activated application's AID. As both the PPSE and PSE are updated, the DTC can be used in contact and contactless transactions with digital transaction devices. The DTC can operate with the appropriate banking applet 415 to effect debit card transactions.

In the example depicted in FIG. 4, three of the script used may include, for example:

### Script 1 (LOCK/UNLOCK Banking Applications):

SELECT SSD;
INITIALIZE UPDATE;
EXTERNAL AUTHENTICATE;
SET STATUS (APPLICATION LOCKED); and
SET STATUS (APPLICATION UNLOCKED).

### Script 2 (UPDATE PPSE FCI):

SELECT PPSE;
INITIALIZE UPDATE;
EXTERNAL AUTHENTICATE; and
UPDATE FCI (FCI CONTENT with AID).

### Script 3 (UPDATE PSE PAYMENT DIRECTORY)

SELECT PSE;
INITIALIZE UPDATE;
EXTERNAL AUTHENTICATE; and
UPDATE FCI PAYMENT DIRECTORY (AID).

Whilst the above examples illustrated in FIGS. 3 and 4 are addressed to changing the operating personality of a DTC, the range of operations which can be performed by using an MCU with appropriate scripts is much broader, and includes actions such as disabling the DTC entirely if a fraudulent or sufficiently suspicious transaction is detected. For example, a DTC may be presented to a digital transaction device, such as an EFTPOS terminal; during the attempted payment transaction, the payment network or the terminal itself detects suspicious activity, for example, multiple entries of an incorrect PIN; the terminal can signal the DTC, which has a script capable of deactivating all VCPs on the DTPU; and the DTC (MCU on the DTC) runs the script to render the DTC inactive.

Further, in other example embodiments, the DTPU of the DTC could store a wide variety of digital transaction documents, including passports, IDs, age verification documents, loyalty cards, travel cards, along with a range of financial transaction documents, such as credit and debit cards from various payment schemes. In one embodiment, the DTC can be operated via its interface to install any one of the documents as the operating personality of the DTC.

In other embodiments, it is envisaged that, for example, multiple personalities could operate where such personalities have some relationship, such as a credit card and a loyalty card. In such scenarios, the PPSE/PSE may only present the credit card personality for selection by a transaction device, but the DTC could operate an associated loyalty card (a different VCP on the DTC) to recognise transactions made with the credit card when it is the active card profile.

In other variations, a single script may be suitable for completing a number of operations for changing a DTC's operating personality. For example, the script may implement a number of authentications and commands required. This would increase the efficiency of each script, thus requiring a smaller number of scripts to be installed on the MCU for executing each personality change operation.

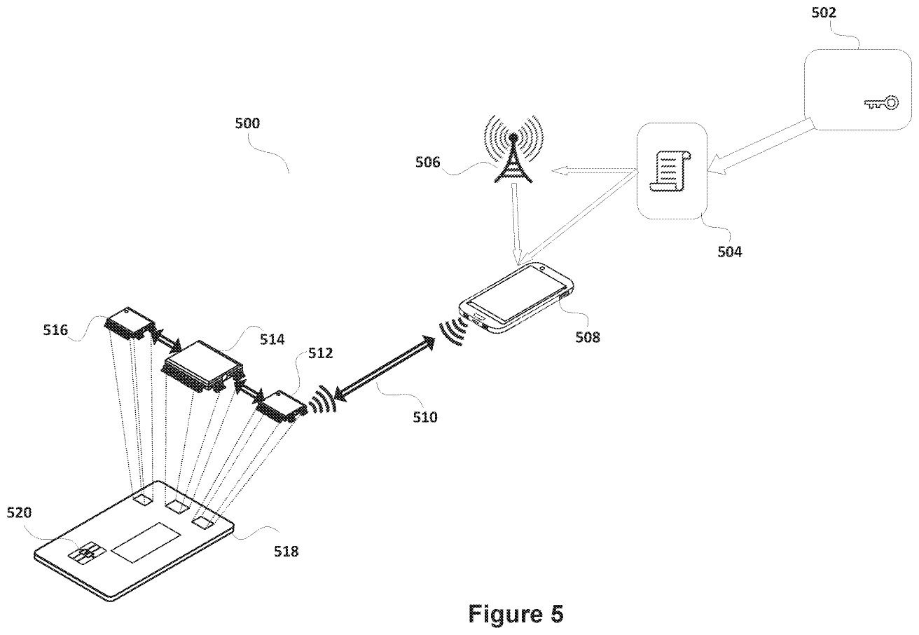

FIG. 5 shows an example embodiment of a communication pathway 500 between a TSM 502 and a DTC 518 for delivering a script 504 from the TSM to the DTC. In one example embodiment, the script is delivered to the MCU 514 on the DTC as an end-point of the communication pathway. In another example embodiment, the script is delivered to the secure memory 516 on the DTC as an end-point of the communication pathway.

The TSM generates the script with a keyset unique to a chosen set of parameters of the DTC. The set of parameters could include, for example, one or more of the following: a DTC unique ID, a MCU unique ID, a key (or keyset) stored in secure memory 516 of the DTC, and a unique ID for the DTPU 520 (in some examples, an EMV chip). The generated script contains commands (ADPU commands) in accordance with, for example, the GPS. As the script is generated with a keyset unique to the chosen parameters, the script cannot be used with other DTCs or other devices (such as mobile payment devices).

The TSM 502 sends the generated script 504 to a mobile device 508 (for example, a DAD or a mobile phone). The TSM can send the script via a secure communication channel, or in the clear. The communication path between the TSM and the mobile device can Over The Air (OTA) 506, or by some other pathway.

The mobile device is then able to transfer the script to the DTC 518 via a contactless communication channel 510 to a communication chip 512. Examples of the contactless communication channel are an NFC connection or a Bluetooth™ connection.

Once transferred to the communication chip 512, the script can be passed to the MCU 514 or further transferred to the secure memory 516. When the script has been received by its designated end-point, an acknowledgement of receipt can be sent back through the same or a different communication pathway to confirm to the TSM that the script has been safely received and stored on the correct DTC or other payment device.

In various embodiments, the communication pathway 500, or parts of the communication pathway can be secured to prevent fraudulent activity, such as man-in-the-middle attacks. However, it will be appreciated that a script is generated for a specific device, and cannot be used in other devices, so that a secure communication pathway may not always be required or desired.

It will also be appreciated that the communication pathway 500 could be established as an end-to-end pathway between the TSM 502 and the end-point (for example, the MCU 514, or the secure memory 516). Such a pathway requires maintenance of all connections between points along the pathway for the entirety of the communication process.

In other embodiments, the communication pathway 500 may be comprised of a series of asynchronous communication points. In such embodiments, a script 504 can be delivered from the TSM 502 to a mid-point device, such as the mobile device 508 via a first communication channel part-pathway. The first communication channel part-pathway could then be dropped. The mobile device, being a temporary holder of the script, can then establish a second communication channel part-pathway with the DTC's communication chip 512, which part-pathway has a synchronous connection with the MCU 514, and can also have a synchronous connection with the secure memory 516. The script can be delivered to the end-point, and an acknowledgement can be sent back through a same mix of synchronous and asynchronous communication channel part-pathways.

In embodiments including asynchronous communication channel part-pathways, the entire communication process (including delivery of the script from the TSM to the end-point, and delivery of the acknowledgement back to the TSM) could be time-limited to reduce the risk of fraudulent interception and use of the script. In some examples, the time limit could be 5 minutes, although it will be appreciated that other time limits could be chosen.

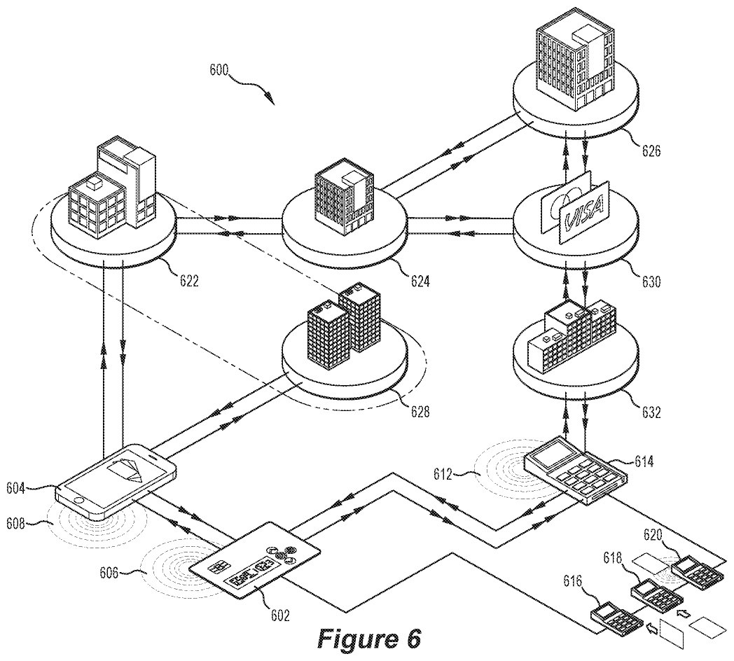

FIG. 6 shows and example environment 600 for issuing a DTC 602, issuing VCPs to the DTC, issuing scripts for the DTC, along with a payment environment for facilitating digital transactions using the DTC when operating with a personality according to one of the VCPs which is activated on the DTC. Typical operating dependencies between each of the entities in this environment are indicated by arrowed lines.

The DTC 602 depicted in FIG. 6 is capable of adopting one of a number of available personalities and once a particular personality has been selected and activated, the DTC may be used to perform digital transactions with an existing digital transaction infrastructure including a merchant terminal 614 and may be used to conduct the transaction with existing digital transaction infrastructure according to the available modes of use of a DTC with a merchant terminal including use of NFC/contactless capabilities 612 for contactless payment 620, physical contact with the EMV contacts 618 or a magnetic stripe on the rear of the DTC 616.

Further, in FIG. 6, an arrangement is depicted wherein the personality adopted by the DTC 602 relates to the selected VCP of a credit card and transactions effected by using the DTC with the adopted personality use tokens to improve the security of the credit card transaction.

In this regard, in the embodiment detailed in FIG. 6, an issuer 626 initially issues the credit or debit card and creates an account for the account holder. The account is identified by a Primary Account Number (PAN) that identifies the issuer and the particular card holder account. Alternatively, the issuer may issue a blank card for subsequent installation of all personalities (represented by VCPs) required by the user. Further, the issuer could also issue a card with a single virtual card installed that is supplied by a TSM 622.

When a consumer uses their DTC 602 in a credit card transaction with a merchant terminal 614, the merchant terminal interacts with an acquirer 632 and passes payment data and the token to the acquirer for authorisation of the transaction.

The acquirer 632 is an entity that processes credit or debit card payments on behalf of a merchant. The merchant acquires a credit card payment from the card issuer 626 within a payment scheme 630. The acquirer exchanges funds with an issuer on behalf of the merchant. With respect to the process associated with the transaction, the acquirer passes the payment data and token received from the merchant to the payment scheme. The payment scheme then requests that a token service provider 624 convert the token collected by the merchant and received from the acquirer back to the associated PAN. The token service provider provides the original PAN to the payment scheme and the payment scheme passes the PAN to the issuer and receives an account number for the payment. The issuer verifies the availability of funds and either authorises or declines the payment and communicates the authorisation or otherwise to the payment scheme. In turn, the payment scheme provides authorisation, or declines to provide authorisation, to the acquirer and the authorisation is provided from the acquirer to the merchant terminal 614. If payment is authorised, the merchant provides the goods and/or services to the user of the DTC and the merchant is assured that it, he or she will receive funds in return for the goods and/or services provided.

Optionally, at the time the issuer 626 issues a credit or debit card and creates an account for the account holder, the issuer provides a request to a TSP 624 to generate tokens for the PAN that identifies the issuer and the particular account holder. In the instance of FIG. 5, since the DTC 602 is operable to adopt one of many different personalities, it can behave in a similar manner to a digital wallet without the constraints that are normally encountered when operating a digital wallet.

FIG. 6 also details a Trusted Service Manager (TSM) 622 which receives tokens from the token service provider 624 for the purpose of creating a virtual card. The TSM securely distributes virtual card data to an account holder's mobile device 604. The role of the TSM is to ensure that virtual card data is securely packaged and transferred to the secure element of a mobile device. The mobile payment data may be secured by keys. In the example of FIG. 5, the TSM generates a virtual card in the form of a CAP file for installation into the mobile device 604 and for transfer onto the DTC 602. CAP files containing virtual card data are transmitted wirelessly to the secure element of a user's mobile device. The TSM is also responsible, in this embodiment, for issuing scripts which allow the DTC to perform operations requiring authorization in accordance with the security hierarchy, including the operations required for changing the operating personality adopted by the DTC 602.

The user's mobile device 604 may be identified by various pieces of information regarding the device, that when considered in combination, form a “mobile device fingerprint.” The mobile device executes a digital wallet application and communicates 608 with the DTC 602 preferably by use of a wireless communication protocol such as NFC or Bluetooth 606.

The user may download a wallet application from a wallet service provider 628 for installation on their mobile device 604 wherein the wallet service provider digital wallet application allows the user to carry virtual credit cards, virtual debit cards or other virtual card information in a digital form on their mobile device. In the instance of FIG. 6, the digital wallet application also includes a module that provides the functionality for the digital wallet application to communicate and interact with the DTC 602. Once the digital wallet application has been downloaded from the wallet service provider to the mobile device, the TSM can identify the mobile device by the “mobile device fingerprint” and can download virtual cards (sometimes in the form of CAP files) for installation into the digital wallet application and hence, becomes available for transfer onto the DTC for use in an existing digital transaction network according to the personality encapsulated within the VCP file.

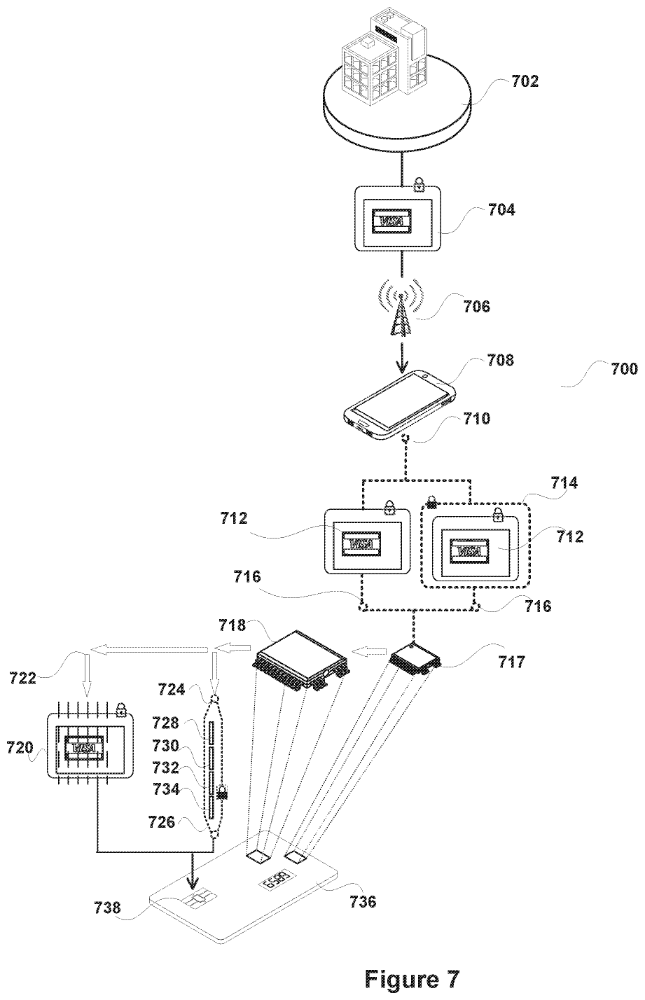

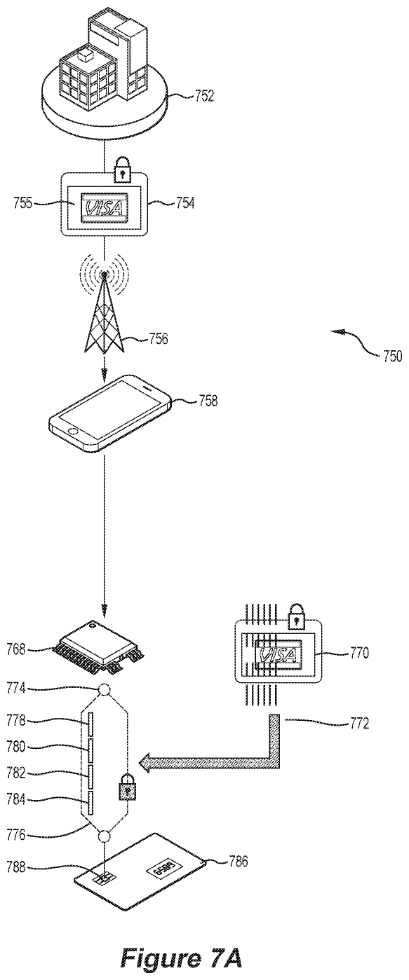

FIG. 7 shows one possible arrangement 700 for providing a VCP 704 to a DTC 736, in this example, via a mobile device such as a smartphone 708. A TSM 702 generates a VCP in cooperation with other card profile issuing entities, such as issuers (which may also be referred to as banks), and transmits the profile securely over the air 706 to a cardholder's smartphone 708. An encrypted profile with EMV ISD keys held within the TSM is linked/matched with EMV ISD keys held within the EMV (738). The VCP is transmitted via a SSL link or similar. The smartphone optionally establishes an end-to-end secure communication link 710, 716 with a communication chip 717 (for example, using NFC or Bluetooth™). The communication chip 717 establishes an end-to-end secure communication link with an MCU 718 on the DTC 736 for secure transfer of an encrypted file 712 (same as 704) relating to the VCP. The file is encrypted using key pairs or SCP 714 in accordance with the security hierarchy.

The MCU transfers the virtual card to the DTC's DPTU 738, an EMV chip in this example, by splitting the VCP into ADPUs 720 and transferring 722 each of the ADPUs to the EMV optionally via a secure session 724. In this example, the secure session comprises 4 ADPUs 728, 730, 732, and 734, each transmitted through the tunnel to the EMV.

FIG. 7A shows an alternative arrangement 750 to that shown in FIG. 7, for providing a VCP 754 to a DTC 786, in this example, via a mobile device such as a smartphone 758. A TSM 752 generates a VCP in cooperation with other card profile issuing entities, such as banks, and transmits the profile securely over the air 756 to a cardholder's smartphone 758. The smartphone communicates with an MCU 768 on the DTC 786 for secure transfer of the file 754 (in this example, for a Visa card 755) relating to the VCP.

The MCU transfers the virtual card to the DTC's DPTU 788, an EMV chip in this example, by splitting the VCP into ADPUs 770 and transferring 772 each of the ADPUs to the EMV optionally via a secure session 774. In this example, the secure session comprises 4 packets 778, 780, 782, and 784, each transmitted through the tunnel to the EMV.

The communication between the smartphone and the MCU without further encryption (in the clear) is possible because the VCP is sent from the TSM to the smartphone as an encrypted file. Further, though the file contains information to verify that the VCP is being installed on the correct DTC, the information is encrypted with keys between the TSM and the EMV chip with checks and balances including device fingerprints and challenge responses to ensure encrypted information is forwarded only to the correct EMV chip. The codified information is associated with the actual data, such as PAN, cardholder's name, etc, in another location. As such, even if the VCP file is intercepted and decrypted, the information contained therein is not immediately useful for identifying the DTC, the cardholder or other critical information.

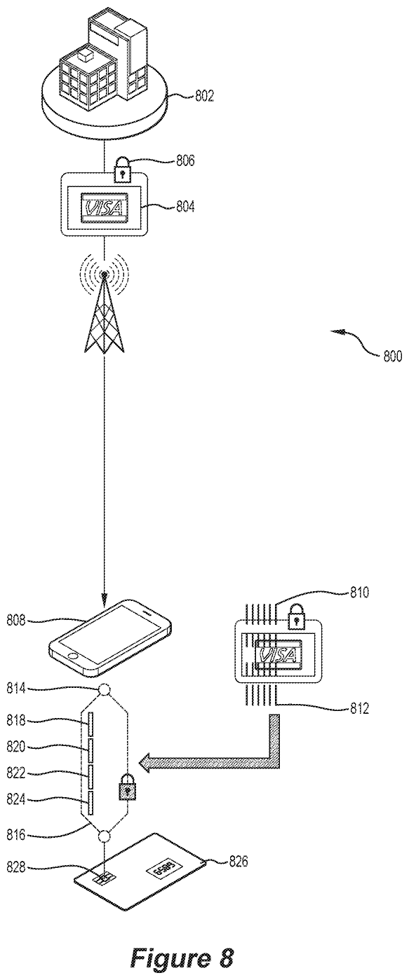

FIG. 8 shows an alternative arrangement 800 to that depicted in FIG. 7 where the VCP 804 is transmitted from the TSM 802 as an end-to-end encrypted (via SCP) VCP file 806 to the cardholder's mobile device 808 and is transferred directly to the DTPU 828 of the cardholder's DTC 826, rather than being transferred through an MCU as depicted in FIG. 7. Similar to the process shown in FIG. 7, the encrypted VCP file 810 stored on the mobile device is split into ADPUs 812 and transmitted, optionally via a secure session 814, with a tunnel 816, the transmission comprising 4 packets 818, 820, 822, and 824, each transmitted through the tunnel to the EMV. It will be appreciated that, in this embodiment, the VCP file is already encrypted with end-to-end by using SCP, optionally the VCP file can be double encrypted with a secure session between phone and EMV chip.

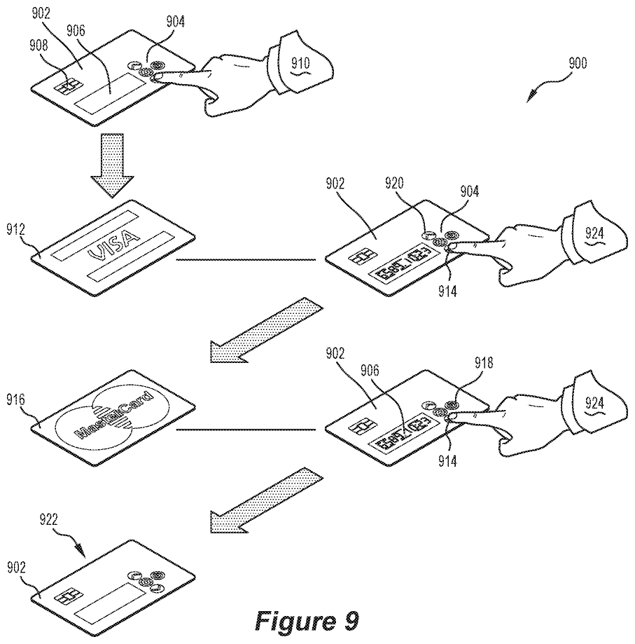

FIG. 9 shows and example scenario 900 where a cardholder 910 changes the operating personality of a DTC 902 using the DTC's interface including card buttons 904 and a display 906. In the example, the DTC starts with a NULL personality, in which case the DTC will not be able to perform any transactions. The cardholder selects a personality desired for a next digital transaction, in this example, a Visa credit card personality 912. After using the DTC for one or more payment transactions, the cardholder may wish to change 924 the DTC's operating personality to that of a MasterCard credit card 916, so the cardholder presses the up and down scroll buttons 920, 914 until the display shows the MasterCard personality, the cardholder then presses a select button to cause the DTC to activate that personality. For security, the DTC can be reverted to a NULL personality 922 until the cardholder wishes to use the DTC for another payment.

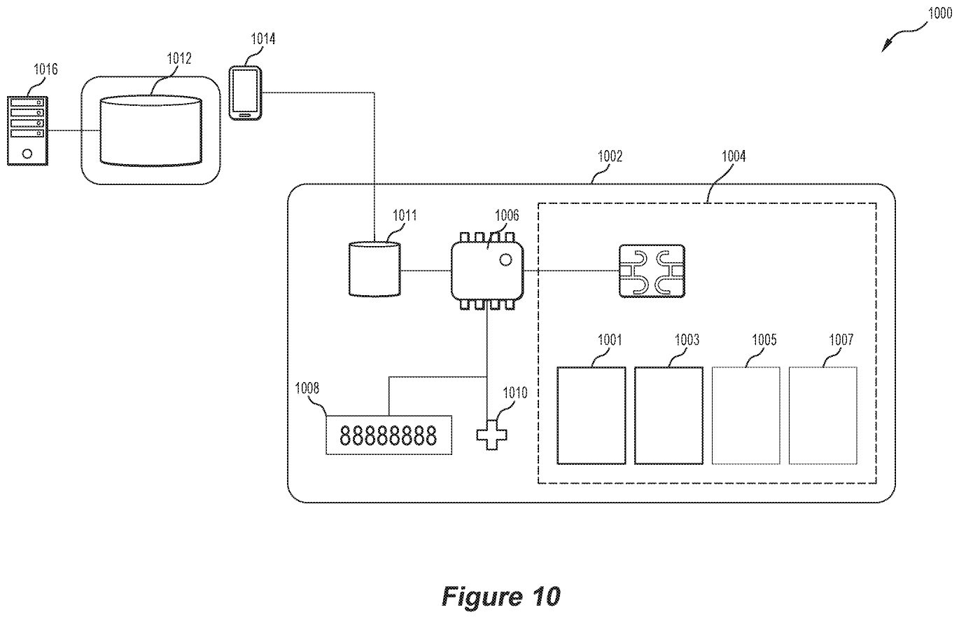

FIG. 10 shows another embodiment 1000 of a DTC in accordance with and embodiment of the present invention. The DTC 1002 (sometimes referred to as a “Companion Card”) includes an EMV chip (DTPU) 1004, the MCU 1006 and a digital screen 1008 with touch controls 1010 to select the payment application (the personality of the DTC presented to a digital transaction device as represented by a VCP loaded on the DTC). The DTC also has a wireless interface (for example, Bluetooth™ or NFC) 1011 for communication with a user's mobile device 1014. The EMV operates with a PPSE applet 1001, a PSE applet 1003, and has various payment applications installed 1005 . . . 1007.

The DTC operated mobile application 1012 on the user's mobile device 1014 provides management features of the DTC for the user. The library included in the mobile application may include the following features:
An HTTPS Administration Agent to receive a connection from a TSM and forward APDUs to the DTC;
APIs for triggering the DTC remote management from the TSM; and,
Bluetooth interface with the DTC using MCU capabilities.

A Trusted Service Manager (TSM) 1016 may be responsible for:
Hosting the Card Content Management Keys (according to Global Platform definition); and,
Managing the DTC lifecycle.

The MCU is a controller with the following functions:
Control the embedded screen;
Provide a Bluetooth connection with the mobile phone; and,
Be able to transfer APDUs from the phone to the EMV chip.

The EMV chips hosts one or more payment application and a customized PSE/PPSE application. The EMV relies GPS for application management.

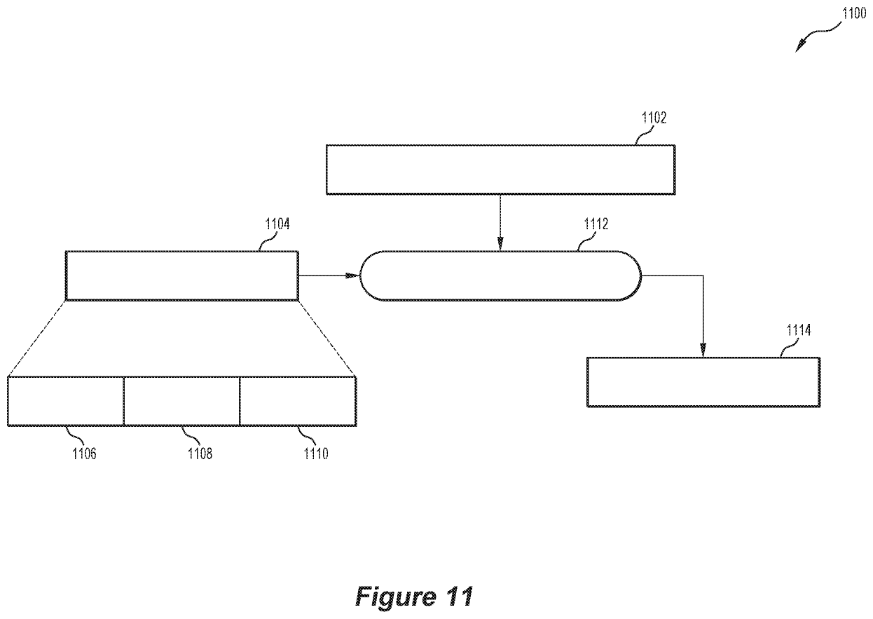

As shown in FIG. 11 in a diagrammatic representation 1100, the MCU must authenticate to the Receiving Entity with the appropriate set of GPS keys. In one example circumstance, the authentication required by SCP02 is mutual and requires the exchange of challenges between the host and the card. In another example circumstance, using SCP02i55 allows using a Pseudo Random Value as a card Challenge.

In FIG. 11, there is depicted elements of generating a session key 1114, including the Secure Channel base key (16 bytes) 1102, and the derivation data (16 bytes) 1104 (made up from a Constant (2 bytes) 1106, a Sequence Counter (2 bytes) 1108, and ‘00’ Padding (12 bytes) 1110), the Secure Channel base key and the Derivation data are fed into a CBC encryption process 1112 to produce the Session Key (16 bytes) 1114.

The pseudo Random is calculated as follows:
The AID of the application requesting opening of a secure channel is padded (in the example shown in FIG. 11, the receiving entity application AID);
A MAC is calculated across the padded data—Single DES Plus Final Triple DES MAC, using the C-MAC session key and an ICV of binary zeroes; and
The six leftmost bytes of the resultant MAC constitute the card challenge.

The MCU and the Secure Element can generate the same well-known pseudo random number if they have the following information:
The SSD base keys;
The AID of the application (on a Java Card, this will be an applet) requesting to open the SCP; and,
The sequence counter used in session keys calculation.

The MCU stores scripts that are generated by the TSM using SCP02i55:
Keys are securely hosted by the TSM;
The script contains APDUs for authentication; and,
Commands required for LOCK mechanisms.

The last step describes the resultant action: activating one application at a time. To do so, the receiving entity:
LOCKS previously activated application
UNLOCKS the application to activate,
   using GPS SSD APIs.

Furthermore, the FCI of the PPSE and the PSE applications are updated with activated application AID. To apply such a resultant action, the receiving entity registers all the applications which should have their state modified.

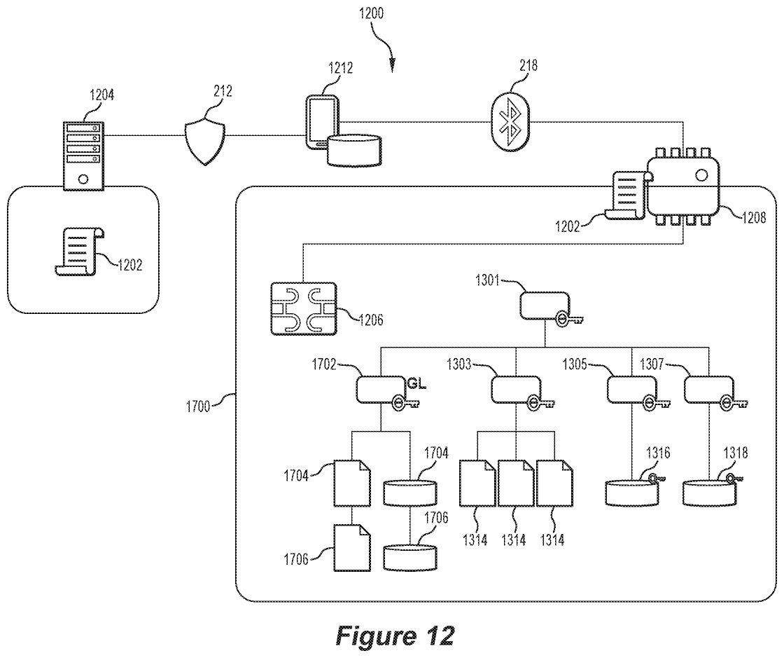

FIG. 12 shows another example embodiment 1200 of the invention using a single script 1202 which can be refreshed by resetting its sequence counter (an alternative to loading a DTC with a number of scripts, each exhausted after performing a given action).

Similar to the example shown in FIG. 2, a script 1202 is stored on the MCU 1208 and is downloaded from the TSM 1204 after the DTC 1210 initiation. To avoid losing synchronization, the sequence counter is reset at the end of each script use by means of a PUT KEY command (a GPS command). The PUT KEY command replaces the existing keyset a with an identical keyset with the same key values, and the script in the MCU remains valid for further use without any update from the TSM. An Update from the TSM will be required on a key update with new values. Updating the key is required on regular basis, as security is compromised the longer a script is not updated. This can be done as a transparent task when the DTC is connected to the user's phone 1212 or another capable device, such as a digital transaction device (ATMs, POS/EFTPOS terminals, etc.).

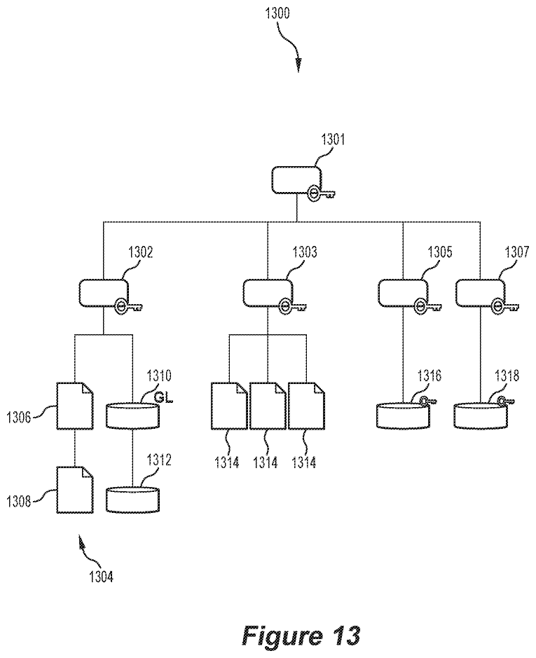

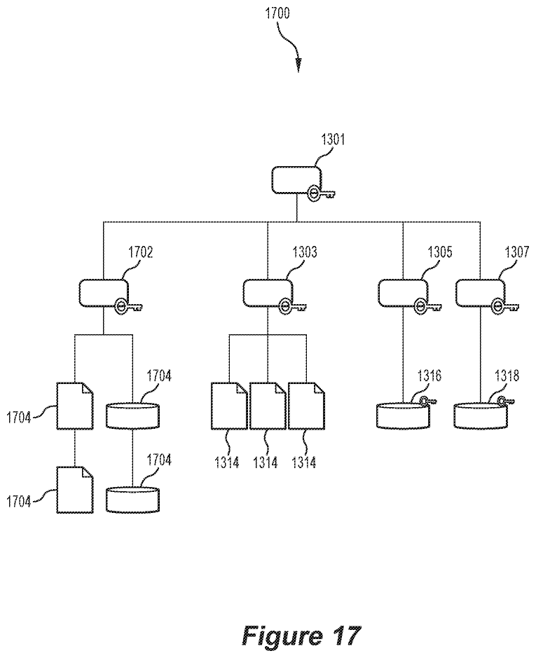

Also shown in FIG. 12 is a security hierarchy 1700 (refer to FIGS. 13 and 17 for details of the nodes in the hierarchy), in which the custom SSD 1702 has the Global Lock (GL) privilege.

In another example embodiment, Global Lock privileges (from GPS standards) are assigned to the PPSE as shown in FIG. 13, which shows a security hierarchy 1300 for such embodiment. The hierarchy introduces a SSD 1302, dedicated to customizing payment environment applications 1304. The following applies for this implementation:
The PPSE is the receiving entity;
SCP02 scripts target the PPSE with AUTHENTICATED security level;
The PPSE manages the selection process;
The MCU builds the scripts using the SET ACTIVATED APPLICATION command; and
PSE is updated by PPSE.

Further implications of the embodiment shown in FIG. 13 include the custom PPSE/PSE applications being stored under this SSD responsibility; the PPSE gets a Global Lock privilege that allows LOCKing/UNLOCKing of other applications on the secure element; and, the keyset for this SSD is used only for LOCKing/UNLOCKing.

In FIG. 13, the custom PPSE is installed under the SSD 1302 as a PPSE package 1306, which is instantiated 1310 with Global Lock privileges. A PSE package 1308 is also installed, and can be instantiated 1312, but without Global Lock privileges.

Under a different SSD for utilities 1303, there are installed payment packages for various schemes (for example, Visa, MasterCard, Amex) 1314. The payment packages are instantiated under various SSDs associated with a financial institution, for example, a bank. In FIG. 13, a Visa payment package 1316 is instantiated under a first SSD 1305 for a first bank, and a MasterCard payment package 1318 is instantiated under a second SSD 1307 for a second bank.

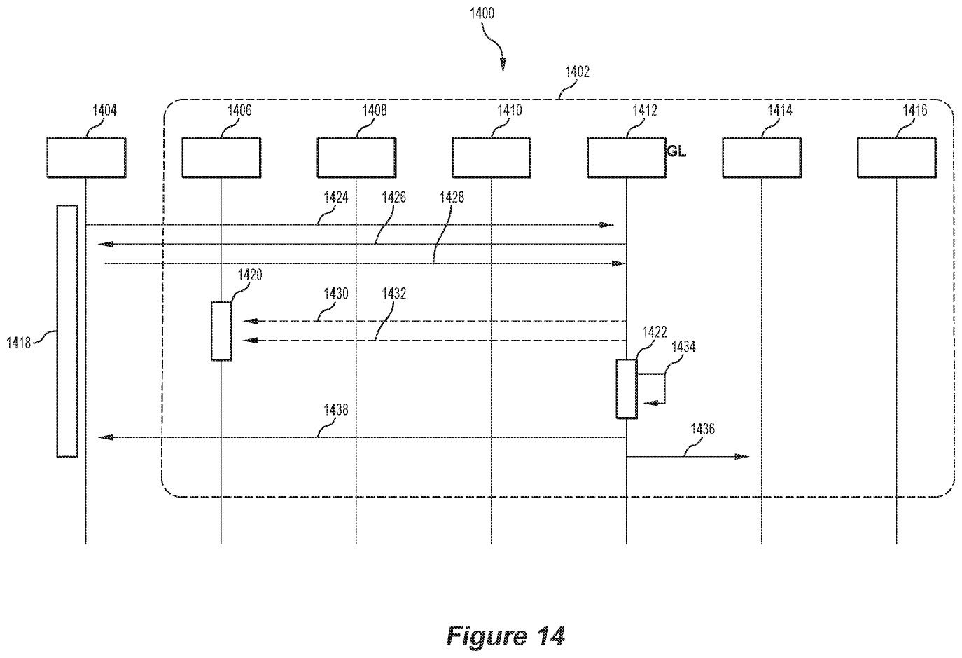

The sequence diagram 1400 shown in FIG. 14 indicates an example process using the security hierarchy of FIG. 13, and includes the following steps:
Step 1: The user operates the embedded screen to select the new active application (App 3);
Step 2: MCU 1404 launches the selection process (in operation with the EMV 1402) by: authenticating 1424/1426 to the SSD through the PSE/PPSE application using custom SSD keys 1302 (see FIG. 13), and sending the Set Active Application command 1428 to the PPSE 1412;
Step 3: the PPSE runs the selection business rule to check the state (LOCK/UNLOCK) 1430/1432 of applications, LOCKs 1430 the deactivated application using GPS APIs 1420, UNLOCKs the application to be activated, and UPDATEs 1434 the FCI 1422 according to the activated application AID; and,
Step 4: the PPSE updates 1436 the PSE 1414 payment directory.

In FIG. 14, the PPSE 1412 has GP Global LOCK privilege. Also shown in FIG. 14 are the ISD 1408, the SSD 1410, and a banking applet 1416. The process shown in FIG. 14 uses a secure channel 1418 for communication between the MCU and the EMV.

In the embodiment shown in FIG. 14, the PPSE 1412 and the PSE 1414 share the same list of AIDS. The sequence counter is shared between all scripts, which implies that each time a script execution is successful, the scripts of other applications that have been generated with the same counter are disabled. Further, each time a selection is performed, one script per banking application installed is disabled.

In the example shown in FIGS. 13 and 14, the MCU is responsible for:
keeping track of the banking application AIDS;
creating the SET ACTIVE APPLICATION command with the target application AID;
appending the SET ACTIVE APPLICATION command to the authentication script; and,
pushing the script to the secure element.

The script contains the APDU commands for Authentication using the SSD 1302 keyset. The secure channel used is SCP02i55. The security level is set to AUTHENTICATED to allow the MCU to add the SET ACTIVE APPLICATION command at the end of the script.

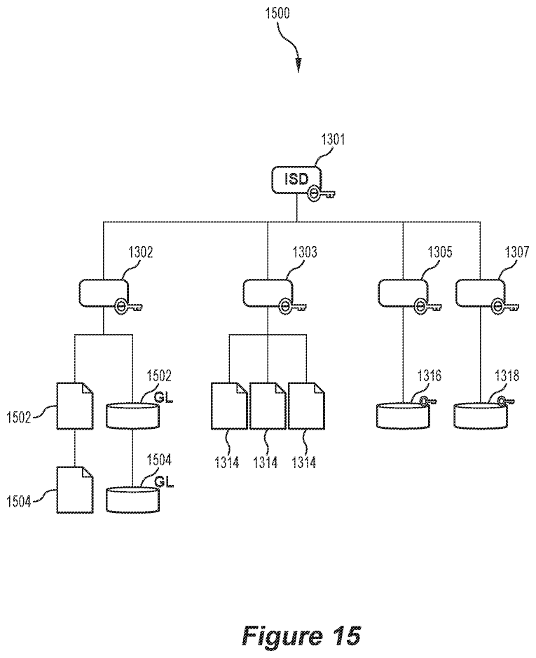

The PPSE implements the business rule for selection processes for all banking applications, both for contact and contactless transactions. FIG. 15 shows an embodiment of a security hierarchy 1500 where the Global Lock privilege is assigned to the PPSE 1502 and the PSE 1504 with the following consequences:
There are 2 receiving entities: the PPSE and the PSE;
SCP02 scripts target the PPSE and the PSE with AUTHENTICATED security level;
The selection process of contact and contactless payment applications are separated;
The MCU builds the scripts using the SET ACTIVATED APPLICATION command; and,
The MCU sends a script to the PPSE and to the PSE for each selection.

Further, Both the PSE and the PPSE have Global Lock privilege, and they both require authentication to use the lock features.

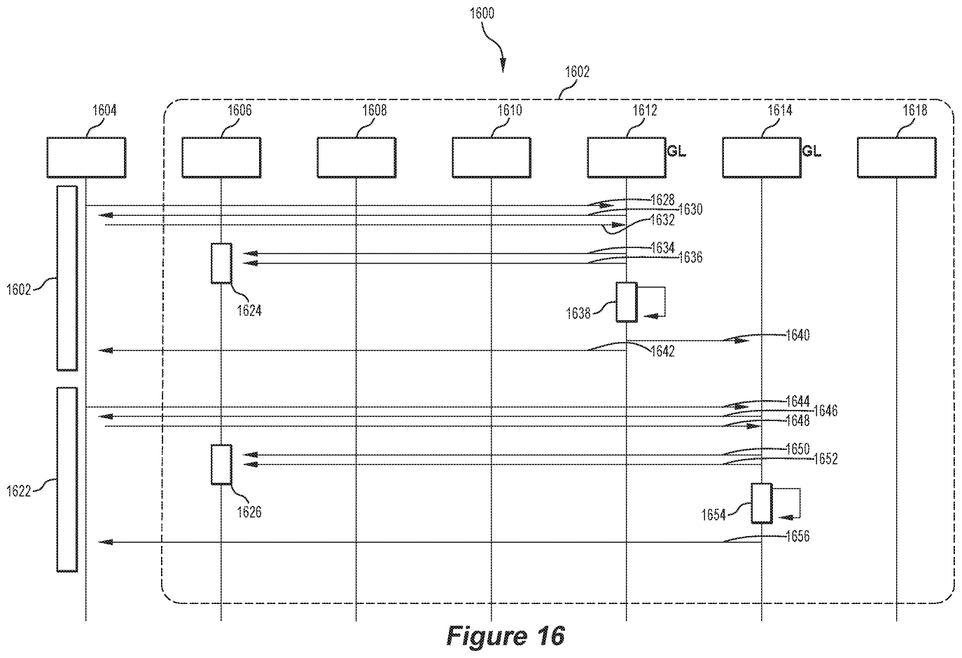

FIG. 16 shows a sequence diagram 1600 which exemplifies a process using the security hierarchy (with the ISD 1608, being atop the hierarchy) shown in FIG. 14, which is implemented in the EMV (DTPU) 1602. The process includes the following steps:
Step 1: The user operates the embedded screen to select the new active application;
Step 2: the MCU 1604 launches the selection process by authenticating 1628 to the SSD 1610 through the PPSE 1612 application using custom SSD keys, and sending the SET ACTIVATED APPLICATION GPS 1630, 1632 command to the PPSE (in this implementation, the PPSE has the Global Lock (GL) privilege);
Step 3: the PPSE runs the selection business rule for contactless cards checking the state (LOCK/UNLOCK) of applications, LOCKing 1634 the deactivated application using GPS API 1624 (which have the state of being OPEN 1606), UNLOCKing 1636 the application to be activated, and UPDATEing the FCI 1638 according to the activated application AID;
Step 4: the PSE 1614 runs the selection business rule for contact cards checking the state (LOCK/UNLOCK) of applications 1644, 1646, 1648, LOCKing 1650 the deactivated application using GPS API 1626, UNLOCKing 1652 the application to be activated, and UPDATEing the payment directory 1654 according to the activated application AID.

The impact on the MCU for the process shown in FIG. 16 is similar to that shown in FIG. 14. However, the number of required scripts is doubled to account for actions performed with the PPSE and the PSE. The scripts contain the APDU commands for authentication using the custom SSD keyset. The secure channel used is SCP02i55 1620, 1622. Both the PPSE and the PSE support authentication. The security level is set to AUTHENTICATED to allow the MCU to add the SET ACTIVE APPLICATION command at the end of the script. The PPSE implements the business rule for selection process for contactless banking applications. The PSE implements the business rule for selection process for contact applications.

Throughout the process shown in FIG. 16, a number of confirmation steps are implemented, whereby “OK” messages 1630, 1642, 1646, 1656 are sent by various actors to confirm a step in the process has been completed successfully. It will also be seen that the PPSE can communicate 1640 with the PSE for updating. Also shown in FIG. 16 is a Banking Applet 1618.

In an example embodiment, as shown in FIG. 17 depicting an example security hierarchy 1700, the Global Lock privilege may be assigned to a custom SSD 1702 with the following implications:
The receiving entity is the custom SSD;
SCP02 scripts target the custom SSD with the AUTHENTICATED security level;
The custom SSD receives only standard commands;
The MCU implements the business logic and generates LOCK/UNLOCK commands; and,
The PPSE and the PSE implement custom commands, respectively, to update their FCI and payment directory.

In the example embodiment shown in FIG. 17, the PPSE 1704 and the PSE 1706 do not have Global Lock (GL) privilege.

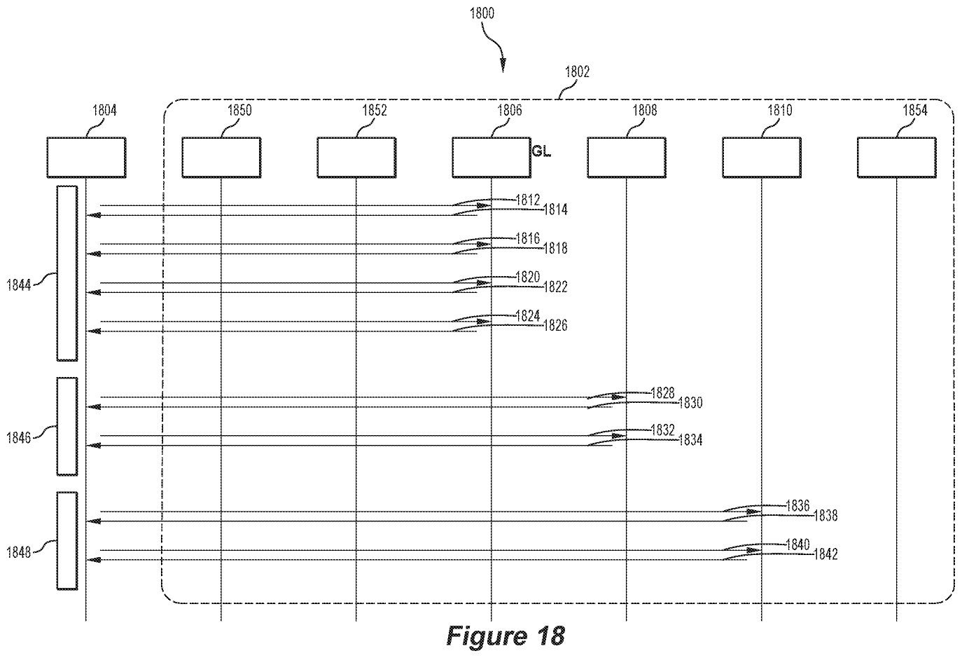

FIG. 18 shows a sequence diagram 1800 which exemplifies a process using the security hierarchy shown in FIG. 17, implemented on the EMV (DTPU) 1802, including an ISD 1852 and an SSD 1806 (the SSD having Global Lock (GL) privilege). The process includes the following steps:
Step 1: The user operates the embedded screen to select the new active application
Step 2: the MCU 1804 runs the selection business rule to check 1812 the state (LOCK/UNLOCK) of applications, select the next available authentication script, append the LOCK command 1820, 1824 to deactivate the presently active application, and, to append the UNLOCK command 1816 to activate the application selected by the user;
Step 3: the MCU updates PPSE 1808 FCI, selects the next available authentication script 1828, and sends a SELECT PPSE command, and UPDATES FCI 1832 according to activated application AID;
Step 4: the MCU updates PSE 1810 payment directory, selects the next available authentication script 1836, and sends a SELECT PSE command, and UPDATES the payment directory 1840 according to activated application AID.

In the embodiment depicted in FIGS. 17 and 18, the MCU implements the business rules, which implies having an up-to-date registry of the activated/deactivated applications. It also implies having the MCU building scripts for both LOCK/UNLOCK mechanisms and the PPSE and the PSE update. However, if the MCU is not a secured device, having such responsibilities may require additional security checks.

Throughout the process shown in FIG. 18, a number of confirmation steps are implemented, whereby “OK” messages 1814, 1818, 1822, 1826, 1830, 1834, 1838, and 1842 are sent by various actors to confirm a step in the process has been completed successfully. Also shown in FIG. 18 is a Banking Applet 1854, and the OPEN state 1850.

The script stored contains the APDU commands for authentication using the custom SSD keyset. The secure channel 1844, 1846, 1848 used is SCP02i55. The security level is set to AUTHENTICATED to allow the MCU to add appropriate set of commands. As the AID of the targeted application enters in the computation of SCP02, 4 different types of scripts are maintained:
For LOCKing
For UNLOCKing;
For UPDATING the PPSE FCI; and
For UPDATING the PSE payment directory.

All 4 scripts may be sent in the same sequence:
1st Script content: (LOCK/deselected banking app):
SELECT SSD
INITIALIZE UPDATE
EXTERNAL AUTHENTICATE
SET STATUS (APPLICATION LOCKED);
2nd Script content: (UNLOCK/Selected banking app):
SELECT SSD
INITIALIZE UPDATE
EXTERNAL AUTHENTICATE
SET STATUS (APPLICATION UNLOCKED);
3rd Script content: (UPDATE PPSE FCI):
SELECT PPSE
INITIALIZE UPDATE
EXTERNAL AUTHENTICATE
UPDATE FCI (FCI CONTENT with AID);
4th Script content: (UPDATE PSE PAYMENT DIRECTORY):
SELECT PSE
INITIALIZE UPDATE
EXTERNAL AUTHENTICATE
UPDATE PAYMENT DIRECTORY (AID).

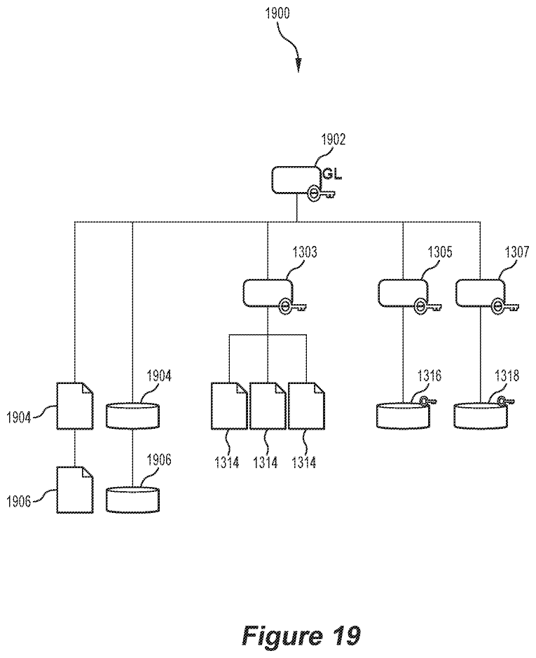

FIG. 19 shows an embodiment of a security hierarchy 1900 where the Global Lock privilege is assigned to the ISD 1902, with the following implications:
The receiving entity is the ISD 1902;
SCP02 scripts target the ISD with AUTHENTICATED+MAC+ENCRYPTED security level: this is the ISD minimum security level;
A specific keyset is created for selection process;
The ISD receives only standard commands;
The MCU implements the business logic;
Commands cannot be appended by the MCU without cryptographic computations; and,
The PPSE 1904 and the PSE 1906 implement custom commands, respectively, to update their FCI and payment directory.

Example of script to use for 4 selections:

| | | | | Script 3 | Script 4 |
|---|---|---|---|---|---|
| | Counter | Script 1 | Script 2 | (UPDATE | (UPDATE |
| | Value | (LOCK) | (UNLOCK) | PPSE) | PSE) |
| 1st selection | 1 | ✓ | ✓ | ✓ | ✓ |
| 2^{nd} selection | 2 | ✓ | ✓ | ✓ | ✓ |
| 3^{rd} selection | 3 | ✓ | ✓ | ✓ | ✓ |
| 4^{th} selection | 4 | ✓ | ✓ | ✓ | ✓ |

Every script is used.

In another example, it is possible for the scripts to share the same keyset. In such circumstances, the sequence counter is shared by all the scripts so each script needs to have a sequence counter increased by 1.

| | | | | Script 3 | Script 4 |
|---|---|---|---|---|---|
| | Counter | Script 1 | Script 2 | (UPDATE | (UPDATE |
| | Value | (LOCK) | (UNLOCK) | PPSE) | PSE) |
| 1st selection | 1 | ✓ | X | X | X |
| | 2 | X | ✓ | X | X |
| | 3 | X | X | ✓ | X |
| | 4 | X | X | X | ✓ |
| 2nd selection | 5 | ✓ | X | X | X |
| | 6 | X | ✓ | X | X |
| | 7 | X | X | ✓ | X |
| | 8 | X | X | X | ✓ |

Scripts marked with a X are discarded (or not generated by the TSM) because the sequence counter is not applicable.

Performing one selection consumes 8 scripts (4 LOCKs and 4 UNLOCKs) per banking application and 8 scripts per selection app (4 PPSE and 4 PSE).

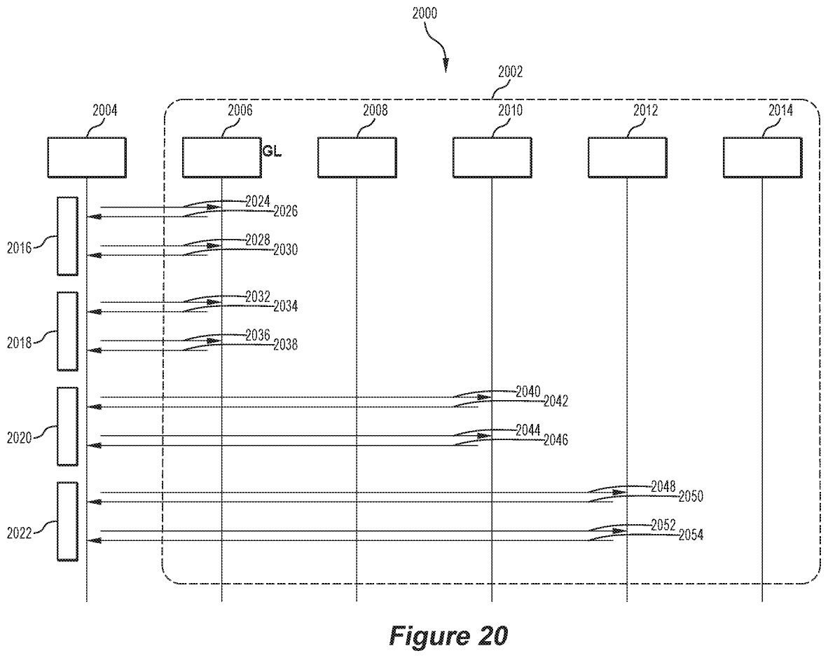

FIG. 20 shows a sequence diagram 2000 which exemplifies a process using the security hierarchy shown in FIG. 19, which is implemented on the EMV (DTPU) 2002. The process includes the following steps:
Step 1: The user uses the embedded screen to select the new active application;
Step 2: the MCU 2004 runs the selection business rule, checks the state (LOCK/UNLOCK) of applications 2024, 2032, selects the set of scripts to run, runs the script with LOCK command 2036 to deactivate the presently active application, and runs the script with UNLOCK command 2028 to activate the application selected by the user;
Step 3: the MCU updates PPSE 2010 FCI, selects the next available authentication script 2040, and sends a SELECT PPSE command and UPDATES FCI 2044 according to activated application AID;
Step 4: the MCU updates the PSE 2012 payment directory, selects the next available authentication script 2048, and sends a SELECT PSE command and UPDATES the Payment Directory 2052 according to activated application AID.

The MCU implements the business rule, which implies having an up-to-date registry of the activated/deactivated applications, and implies having the MCU building scripts for both LOCK/UNLOCK mechanisms and the PPSE and PSE update. The authentication scripts use ISD keys, which are the most sensitive keys of the secure element as they can grant card content management capabilities. In GPS, the minimum security level of the ISD mandates that the script is obtained only from the TSM and not appended in the MCU. Further, a large number of scripts may need to be stored for this example implementation. However, if the MCU is not a secured device, having such responsibilities may require additional security checks.

The script stored contains the APDU commands for Authentication using the custom SSD 2008 keyset. The secure channel 2016, 2018, 2020, 2022 used is SCP02i55. The security level is set to AUTHENTICATED+MAC+ENCRYPTION by the ISD 2006 (which has the Global Lock (GL) privilege). The MCU is not capable of appending the script with new commands, so the LOCK and UNLOCK commands need to be generated by the TSM.

Throughout the process shown in FIG. 20, a number of confirmation steps are implemented, whereby “OK” messages 2026, 2030, 2034, 2038, 2042, 2046, 2050, and 2054 are sent by various actors to confirm a step in the process has been completed successfully. Also shown in FIG. 20 is a Banking Applet 2014.

As previously discussed, in embodiments, scripts which are used to perform a selection of a VCP cannot be reused, and may be discarded. This requires replenishment of the scripts to allow a user of a DTC with a plurality of VCPs to change between personalities represented by the VCPs.

In an embodiment, scripts are replenished when the number of available scripts falls to a predetermined threshold. The cardholder can be notified by a warning signal on the DTC, such as an icon on the DTC display, or by an audible alarm. The cardholder may also be warned by means off the card, such as an SMS to their mobile phone.

The cardholder can replenish scripts by sending a request to a TSM via a mobile phone, an ATM, an EFTPOS/POS terminal, or some other suitable means, whereupon the TSM can use a keyset specific to the cardholder's DTC (for example, the keyset may be specific to the EMV on the DTC) to generate new scripts. The scripts can be sent securely via the means (mobile phone, ATM, EFTPOS/POS) to be downloaded into the MCU of the DTC.

It will be appreciated that the scripts, having been created with the keyset specific to the cardholder's DTC, cannot be used with another DTC. In this regard, scripts which are intercepted by a third party cannot be maliciously used to operate other VCPs on another DTC.

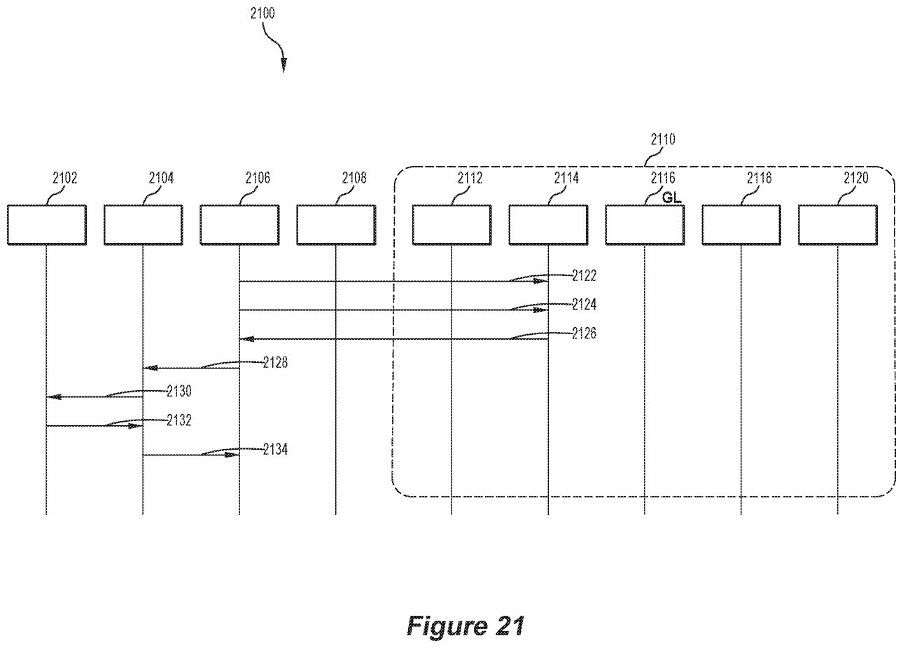

FIG. 21 shows an example replenishment functional sequence 2100, operating with a DTC having an EMV (DTPU) 2110 and a security hierarchy including an ISD 2112, and a custom SSD 2114, along with a PPSE 2116, A PSE 2118 and a Banking Applet 2120, wherein:
Step 1: The user performs a selection. The number of available offline selection (sequence counter threshold) is exceeded;
Step 2: On the next connection to the mobile phone 2104:
   The MCU 2106 selects 2122 the custom SSD 2114 sends the INITIALIZE UPDATE APDU command 2124 to get the sequence counter value from the custom SSD, with the state of the MCU to EMV communication channel being OPEN 2108,
   The MCU pushes to the phone a request 2128 to replenish the scripts, including the counter value;
Step 3: The phone forwards 2130 this request to the TSM 2102;
Step 4: The TSM generates N new scripts for the MCU:
   Using SCP02i55 with the custom SSD SCP keys and the sequence counter received in the request,
   Forwards 2132 the script to the MCU through the phone connectivity. Using SCP02i55 with the custom SSD SCP keys and the sequence counter received in the request,
   Forwards 2134 the script to the MCU through a mobile phone connection.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not and should not be taken as an acknowledgement or any form of suggestion that the prior art forms part of the common general knowledge.

What is claimed is:

1. Apparatus on a Digital Transaction Card (DTC), the apparatus comprising:
a Digital Transaction Processing Unit (DTPU) operable for executing an instruction from a standard command protocol,
wherein the DTC is operable to store one or more scripts, each script including one or more instructions from the standard command protocol, the DTC further operable to cause the DTPU to execute the one or more instructions.

2. Apparatus of claim 1, further comprising:
an off-card entity operable to provide at least one script to the DTC.

3. Apparatus of claim 2, wherein the off-card entity is a Trusted Service Manager (TSM).

4. Apparatus of claim 3, wherein the TSM is adapted to generate one or more scripts for a uniquely identified DTPU and provide scripts to the DTC including the uniquely identified DTPU.

5. Apparatus of claim 1, wherein the apparatus includes software operable to store one or more software packages, at least one of the one or more software packages representing a Virtual Card Profile (VCP), the apparatus operable with the VCP to cause the DTC to adopt the personality associated with the VCP.

6. Apparatus of claim 1, wherein the standard command protocol is the Global Platform Standard (GPS).

7. Apparatus of claim 1, wherein the DTC includes a Micro Controller Unit (MCU).

8. Apparatus of claim 7, wherein the MCU is configured to emulate at least some functions of a digital transaction device, such as an Automatic Teller Machine (ATM), a Point Of Sale (POS) terminal, or an Electronic Funds Transfer at Point Of Sale (EFTPOS) terminal.

9. Apparatus of claim 1, wherein the DTC is operable to refresh one or more scripts.

10. Apparatus of claim 9, wherein the DTC refreshes the one or more scripts by resetting an anti-replay counter on each of the one or more scripts.

11. Apparatus of claim 10, wherein the DTC obtains a current anti-replay counter value from the DTPU and uses the DTPU anti-replay counter value to calculate the anti-replay counter reset value for each of the one or more scripts.

12. Apparatus of claim 1, wherein the DTC is operable to be linked with a Data Assistance Device (DAD) for communication therebetween.

13. Apparatus of claim 12, wherein the DAD is any one of: a smartphone, a Personal Computer (PC), a tablet computing device, and a DTD adapted to operate as a DAD.

14. A method for operating an apparatus on a Digital Transaction Card (DTC), the apparatus comprising a Digital Transaction Processing Unit (DTPU) operable for executing an instruction from a standard command protocol, wherein the DTC is operable to store one or more scripts, each script including one or more instructions from the standard command protocol, the DTC further operable to cause the DTPU to execute the one or more instructions, the method comprising:
operating the apparatus to cause the DTPU to execute the one or more instructions.

15. The method of claim 14, wherein the apparatus further comprises software operable to store one or more software packages, at least one of the one or more software packages representing a Virtual Card Profile (VCP), the apparatus operable with the VCP to cause the DTC to adopt the personality associated with the VCP, the method further comprising:
operating the apparatus to cause the DTPU to execute the one or more instructions to cause the DTC to adopt the personality associated with the VCP.

16. Method of claim 14, further comprising:
operating an off-card entity operable to provide at least one script to the DTC.

17. Method of claim 16, wherein the off-card entity is a Trusted Service Manager (TSM).

18. Method of claim 17, wherein the TSM is adapted to generate one or more scripts for a uniquely identified DTPU and provide scripts to the DTC including the uniquely identified DTPU.

19. Method of claim 14, wherein the apparatus includes software operable to store one or more software packages, at least one of the one or more software packages representing a Virtual Card Profile (VCP), the apparatus operable with the VCP to cause the DTC to adopt the personality associated with the VCP.

20. Method of claim 14, wherein the standard command protocol is the Global Platform Standard (GPS).

21. Method of claim 14, wherein the DTC includes a Micro Controller Unit (MCU).

22. Method of claim 21, wherein the MCU is configured to emulate at least some functions of a digital transaction device, such as an Automatic Teller Machine (ATM), a Point Of Sale (POS) terminal, or an Electronic Funds Transfer at Point Of Sale (EFTPOS) terminal.

23. Method of claim 14, wherein the DTC is operable to refresh one or more scripts.

24. Method of claim 23, wherein the DTC refreshes the one or more scripts by resetting an anti-replay counter on each of the one or more scripts.

25. Method of claim 24, wherein the DTC obtains a current anti-replay counter value from the DTPU and uses the DTPU anti-replay counter value to calculate the anti-replay counter reset value for each of the one or more scripts.

26. Method of claim 14, wherein the DTC is operable to be linked with a Data Assistance Device (DAD) for communication therebetween.

27. Method of claim 26, wherein the DAD is any one of: a smartphone, a Personal Computer (PC), a tablet computing device, and a DTD adapted to operate as a DAD.

28. Method of claim 14, further comprising receiving, from an issuing authority, the DTC configured to store the one or more scripts and to cause the DTPU to execute the one or more instructions.

29. Method of claim 14, further comprising including issuing, by an issuing authority, operating code, including software and/or firmware, to the DTC to enable the DTC to store the one or more scripts and to cause the DTPU to execute the one or more instructions.
